(19) United States
(12) Patent Application Publication
(10) Pub. No.: US 2023/0375673 A1
(43) Pub. Date: Nov. 23, 2023

(54) DYNAMIC ALIGNMENT OF A LIDAR USING DEDICATED FEEDBACK SENSING ELEMENTS

(71) Applicant: Innoviz Technologies Ltd., Rosh Haayin (IL)

(72) Inventors: Idan Bakish, Hod Hasharon (IL); Shahar Levy, Rishon LeZion (IL); David Cohen, Nesher (IL)

(73) Assignee: Innoviz Technologies Ltd., Rosh Haayin (IL)

(21) Appl. No.: 18/316,212

(22) Filed: May 11, 2023

Related U.S. Application Data
(60) Provisional application No. 63/340,962, filed on May 12, 2022.

(51) Int. Cl. G01S 7/481; G01S 17/931

(52) U.S. Cl. CPC G01S 7/4816; G01S 17/931

(57) ABSTRACT

A distance measurement (DM) optical sensor that includes (i) a 2D sensing array that includes sensing elements that include DM sensing elements and feedback sensing elements that are statically allocated to act as feedback sensing elements, (ii) output paths that include DM output paths and feedback output paths; and (iii) one or more processing circuits that are configured to: (a) trigger an outputting of DM output signals, trigger an outputting of feedback output signals, and (b) process the feedback output signals to determine a spatial relationship between an actual location of light sensed by at least some of the sensing elements and an expected location of the light.

### CROSS REFERENCE

This application claims priority from U.S. provisional patent Ser. No. 63/340,962 filing date May 12, 2022, which is incorporated herein by reference.

### BACKGROUND

### I. Technical Field

The present disclosure relates generally to surveying technology for scanning a surrounding environment, and, more specifically, to systems and methods that use LIDAR technology to detect objects in the surrounding environment.

### II. Background Information

With the advent of driver assist systems and autonomous vehicles, automobiles need to be equipped with systems capable of reliably sensing and interpreting their surroundings, including identifying obstacles, hazards, objects, and other physical parameters that might impact navigation of the vehicle. To this end, a number of differing technologies have been suggested including radar, LIDAR, camera-based systems, operating alone or in a redundant manner.

One consideration with driver assistance systems and autonomous vehicles is an ability of the system to determine surroundings across different conditions including, rain, fog, darkness, bright light, and snow. A light detection and ranging system, (LIDAR a.k.a LADAR) is an example of technology that can work well in differing conditions, by measuring distances to objects by illuminating objects with light and measuring the reflected pulses with a sensor. A laser is one example of a light source that can be used in a LIDAR system. As with any sensing system, in order for a LIDAR-based sensing system to be fully adopted by the automotive industry, the system should provide reliable data enabling detection of far-away objects.

The systems and methods of the present disclosure are directed towards improving performance of LIDAR systems.

### BRIEF DESCRIPTION OF THE DRAWINGS

The accompanying drawings, which are incorporated in and constitute a part of this disclosure, illustrate various disclosed embodiments. In the drawings:

FIG. 1 illustrates an example of a LIDAR system;

FIGS. 2 and 3 illustrate various configurations of a projecting unit and its role in a LIDAR system;

FIG. 4 is a cross cut diagram of a part of a sensor;

FIGS. 5 and 6 depict various configurations of a sensing unit and its role in a LIDAR system;

FIG. 7 demonstrates a scenario in which a LIDAR can benefit from dynamic alignment;

FIG. 8 illustrates a conceptual architecture of a LIDAR;

FIG. 9 illustrates various misalignments in LIDARs and their effect on signal detection;

FIG. 10 the top part illustrates an aligned mirror and the lower part;

FIG. 11 achieved by shifting the lens by a distance equal;

FIG. 12 illustrates a compensation Look-Up-Table (LUT);

FIG. 13 illustrates a compensation Look-Up-Table (LUT);

FIG. 14 illustrates example of motion types that can be applied;

FIG. 15A illustrates an example of an array of sensing elements;

FIGS. 15B-15L illustrate examples of arrays of sensing elements and arrays of spots;

FIG. 15M illustrates examples of spot geometries;

FIGS. 16A-16D illustrate examples of an optical unit;

FIG. 16E illustrate examples of a sensing array and manipulators;

FIGS. 17A-17B illustrate examples of LIDARs;

FIG. 18 illustrate an example of a LIDAR;

FIGS. 19A-19D illustrate examples of methods;

FIGS. 20A-20G illustrate examples of arrays of sensing elements;

FIG. 21 illustrates an example of sensing elements and their connectivity;

FIG. 22 illustrates an example of reflected light from objects located at different directions from a LIDAR;

FIG. 23 illustrates an example of a set of DM sensing elements and possible locations of feedback sensing elements that are allocated to the set of DM sensing elements;

FIG. 24 illustrates an example of a method; and

FIGS. 25A-25E illustrate examples of DM optical sensors.

### DETAILED DESCRIPTION

The accompanying drawings, which are incorporated in and constitute a part of this disclosure, illustrate various disclosed embodiments. The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

### Terms Definitions

Disclosed embodiments may involve an optical system. As used herein, the term “optical system” broadly includes any system that is used for the generation, detection and/or manipulation of light. By way of example only, an optical system may include one or more optical components for generating, detecting and/or manipulating light. For example, light sources, lenses, mirrors, prisms, beam splitters, collimators, polarizing optics, optical modulators, optical switches, optical amplifiers, optical detectors, optical sensors, fiber optics, semiconductor optic components, while each not necessarily required, may each be part of an optical system. In addition to the one or more optical components, an optical system may also include other non-optical components such as electrical components, mechanical components, chemical reaction components, and semiconductor components. The non-optical components may cooperate with optical components of the optical system. For example, the optical system may include at least one processor for analyzing detected light.

Consistent with the present disclosure, the optical system may be a LIDAR system. As used herein, the term “LIDAR system” broadly includes any system which can determine values of parameters indicative of a distance between a pair of tangible objects based on reflected light. In one embodiment, the LIDAR system may determine a distance between a pair of tangible objects based on reflections of light emitted by the LIDAR system. As used herein, the term “determine distances” broadly includes generating outputs which are indicative of distances between pairs of tangible objects. The determined distance may represent the physical dimension between a pair of tangible objects. By way of example only, the determined distance may include a line of flight distance between the LIDAR system and another tangible object in a field of view of the LIDAR system. In another embodiment, the LIDAR system may determine the relative velocity between a pair of tangible objects based on reflections of light emitted by the LIDAR system. Examples of outputs indicative of the distance between a pair of tangible objects include: a number of standard length units between the tangible objects (e.g. number of meters, number of inches, number of kilometers, number of millimeters), a number of arbitrary length units (e.g. number of LIDAR system lengths), a ratio between the distance to another length (e.g. a ratio to a length of an object detected in a field of view of the LIDAR system), an amount of time (e.g. given as standard unit, arbitrary units or ratio, for example, the time it takes light to travel between the tangible objects), one or more locations (e.g. specified using an agreed coordinate system, specified in relation to a known location), and more.

The LIDAR system may determine the distance between a pair of tangible objects based on reflected light. In one embodiment, the LIDAR system may process detection results of a sensor which creates temporal information indicative of a period of time between the emission of a light signal and the time of its detection by the sensor. The period of time is occasionally referred to as “time of flight” of the light signal. In one example, the light signal may be a short pulse, whose rise and/or fall time may be detected in reception. Using known information about the speed of light in the relevant medium (usually air), the information regarding the time of flight of the light signal can be processed to provide the distance the light signal traveled between emission and detection. In another embodiment, the LIDAR system may determine the distance based on frequency phase-shift (or multiple frequency phase-shift). Specifically, the LIDAR system may process information indicative of one or more modulation phase shifts (e.g. by solving some simultaneous equations to give a final measure) of the light signal. For example, the emitted optical signal may be modulated with one or more constant frequencies. The at least one phase shift of the modulation between the emitted signal and the detected reflection may be indicative of the distance the light traveled between emission and detection. The modulation may be applied to a continuous wave light signal, to a quasi-continuous wave light signal, or to another type of emitted light signal. It is noted that additional information may be used by the LIDAR system for determining the distance, e.g. location information (e.g. relative positions) between the projection location, the detection location of the signal (especially if distanced from one another), and more.

In some embodiments, the LIDAR system may be used for detecting a plurality of objects in an environment of the LIDAR system. The term “detecting an object in an environment of the LIDAR system” broadly includes generating information which is indicative of an object that reflected light toward a detector associated with the LIDAR system. If more than one object is detected by the LIDAR system, the generated information pertaining to different objects may be interconnected, for example a car is driving on a road, a bird is sitting on the tree, a man touches a bicycle, a van moves towards a building. The dimensions of the environment in which the LIDAR system detects objects may vary with respect to implementation. For example, the LIDAR system may be used for detecting a plurality of objects in an environment of a vehicle on which the LIDAR system is installed, up to a horizontal distance of 100 m (or 200 m, 300 m, etc.), and up to a vertical distance of 10 m (or 25 m, 50 m, etc.). In another example, the LIDAR system may be used for detecting a plurality of objects in an environment of a vehicle or within a predefined horizontal range (e.g., 25°, 50°, 100°, 180°, etc.), and up to a predefined vertical elevation (e.g., ±10°, ±20°, +40°-20°, ±90° or 0°-90°).

As used herein, the term “detecting an object” may broadly refer to determining an existence of the object (e.g., an object may exist in a certain direction with respect to the LIDAR system and/or to another reference location, or an object may exist in a certain spatial volume). Additionally or alternatively, the term “detecting an object” may refer to determining a distance between the object and another location (e.g. a location of the LIDAR system, a location on earth, or a location of another object). Additionally or alternatively, the term “detecting an object” may refer to identifying the object (e.g. classifying a type of object such as car, plant, tree, road; recognizing a specific object (e.g., the Washington Monument); determining a license plate number; determining a composition of an object (e.g., solid, liquid, transparent, semitransparent); determining a kinematic parameter of an object (e.g., whether it is moving, its velocity, its movement direction, expansion of the object). Additionally or alternatively, the term “detecting an object” may refer to generating a point cloud map in which every point of one or more points of the point cloud map correspond to a location in the object or a location on a face thereof. In one embodiment, the data resolution associated with the point cloud map representation of the field of view may be associated with 0.1°×0.1° or 0.3°×0.3° of the field of view.

Consistent with the present disclosure, the term “object” broadly includes a finite composition of matter that may reflect light from at least a portion thereof. For example, an object may be at least partially solid (e.g. cars, trees); at least partially liquid (e.g. puddles on the road, rain); at least partly gaseous (e.g. fumes, clouds); made from a multitude of distinct particles (e.g. sand storm, fog, spray); and may be of one or more scales of magnitude, such as ˜1 millimeter (mm), ˜5 mm, ˜10 mm, ˜50 mm, ˜100 mm, ˜500 mm, ˜1 meter (m), ˜5 m, ˜10 m, ˜50 m, ˜100 m, and so on. Smaller or larger objects, as well as any size in between those examples, may also be detected. It is noted that for various reasons, the LIDAR system may detect only part of the object. For example, in some cases, light may be reflected from only some sides of the object (e.g., only the side opposing the LIDAR system will be detected); in other cases, light may be projected on only part of the object (e.g. laser beam projected onto a road or a building); in other cases, the object may be partly blocked by another object between the LIDAR system and the detected object; in other cases, the LIDAR's sensor may only detects light reflected from a portion of the object, e.g., because ambient light or other interferences interfere with detection of some portions of the object.

Consistent with the present disclosure, a LIDAR system may be configured to detect objects by scanning the environment of LIDAR system. The term “scanning the environment of LIDAR system” broadly includes illuminating the field of view or a portion of the field of view of the LIDAR system. In one example, scanning the environment of LIDAR system may be achieved by moving or pivoting a light deflector to deflect light in differing directions toward different parts of the field of view. In another example, scanning the environment of LIDAR system may be achieved by changing a positioning (i.e. location and/or orientation) of a sensor with respect to the field of view. In another example, scanning the environment of LIDAR system may be achieved by changing a positioning (i.e. location and/or orientation) of a light source with respect to the field of view. In yet another example, scanning the environment of LIDAR system may be achieved by changing the positions of at least one light source and of at least one sensor to move rigidly respect to the field of view (i.e. the relative distance and orientation of the at least one sensor and of the at least one light source remains).

As used herein the term “field of view of the LIDAR system” may broadly include an extent of the observable environment of LIDAR system in which objects may be detected. It is noted that the field of view (FOV) of the LIDAR system may be affected by various conditions such as but not limited to: an orientation of the LIDAR system (e.g. is the direction of an optical axis of the LIDAR system); a position of the LIDAR system with respect to the environment (e.g. distance above ground and adjacent topography and obstacles); operational parameters of the LIDAR system (e.g. emission power, computational settings, defined angles of operation), etc. The field of view of LIDAR system may be defined, for example, by a solid angle (e.g. defined using ϕ, θ angles, in which ϕ and θ are angles defined in perpendicular planes, e.g. with respect to symmetry axes of the LIDAR system and/or its FOV). In one example, the field of view may also be defined within a certain range (e.g. up to 200 m).

Similarly, the term “instantaneous field of view” may broadly include an extent of the observable environment in which objects may be detected by the LIDAR system at any given moment. For example, for a scanning LIDAR system, the instantaneous field of view is narrower than the entire FOV of the LIDAR system, and it can be moved within the FOV of the LIDAR system in order to enable detection in other parts of the FOV of the LIDAR system. The movement of the instantaneous field of view within the FOV of the LIDAR system may be achieved by moving a light deflector of the LIDAR system (or external to the LIDAR system), so as to deflect beams of light to and/or from the LIDAR system in differing directions. In one embodiment, LIDAR system may be configured to scan scene in the environment in which the LIDAR system is operating. As used herein the term “scene” may broadly include some or all of the objects within the field of view of the LIDAR system, in their relative positions and in their current states, within an operational duration of the LIDAR system. For example, the scene may include ground elements (e.g. earth, roads, grass, sidewalks, road surface marking), sky, man-made objects (e.g. vehicles, buildings, signs), vegetation, people, animals, light projecting elements (e.g. flashlights, sun, other LIDAR systems), and so on.

Any reference to the term “actuator” should be applied mutatis mutandis to the term “manipulator”. Non-limiting examples of manipulators include Micro-Electro-Mechanical Systems (MEMS) actuators, Voice Coil Magnets, motors, piezoelectric elements, and the like. It should be noted that a manipulator may be merged with a temperature control unit.

Disclosed embodiments may involve obtaining information for use in generating reconstructed three-dimensional models. Examples of types of reconstructed three-dimensional models which may be used include point cloud models, and Polygon Mesh (e.g. a triangle mesh). The terms “point cloud” and “point cloud model” are widely known in the art, and should be construed to include a set of data points located spatially in some coordinate system (i.e., having an identifiable location in a space described by a respective coordinate system). The term “point cloud point” refer to a point in space (which may be dimensionless, or a miniature cellular space, e.g. 1 cm3), and whose location may be described by the point cloud model using a set of coordinates (e.g. (X,Y,Z), (r,ϕ,θ)). By way of example only, the point cloud model may store additional information for some or all of its points (e.g. color information for points generated from camera images). Likewise, any other type of reconstructed three-dimensional model may store additional information for some or all of its objects. Similarly, the terms “polygon mesh” and “triangle mesh” are widely known in the art, and are to be construed to include, among other things, a set of vertices, edges and faces that define the shape of one or more 3D objects (such as a polyhedral object). The faces may include one or more of the following: triangles (triangle mesh), quadrilaterals, or other simple convex polygons, since this may simplify rendering. The faces may also include more general concave polygons, or polygons with holes. Polygon meshes may be represented using differing techniques, such as: Vertex-vertex meshes, Face-vertex meshes, Winged-edge meshes and Render dynamic meshes. Different portions of the polygon mesh (e.g., vertex, face, edge) are located spatially in some coordinate system (i.e., having an identifiable location in a space described by the respective coordinate system), either directly and/or relative to one another. The generation of the reconstructed three-dimensional model may be implemented using any standard, dedicated and/or novel photogrammetry technique, many of which are known in the art. It is noted that other types of models of the environment may be generated by the LIDAR system.

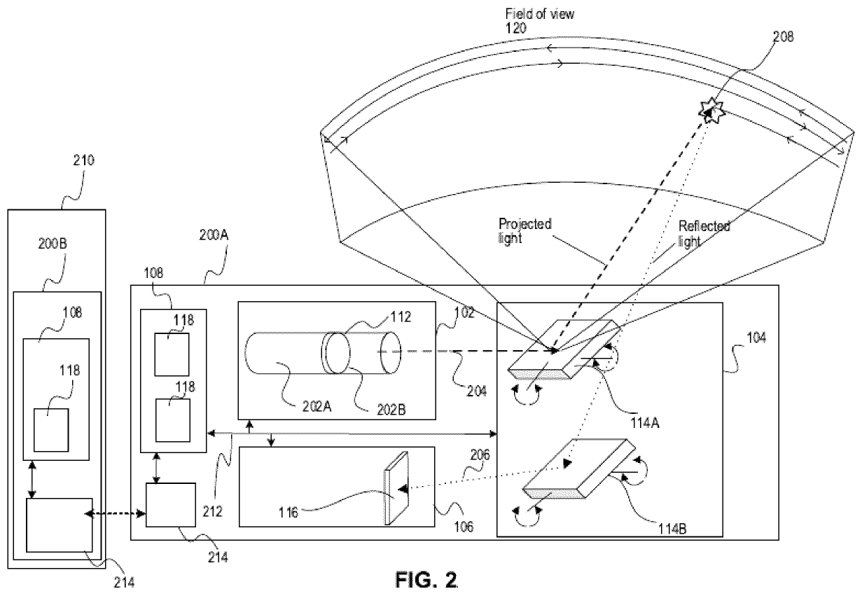

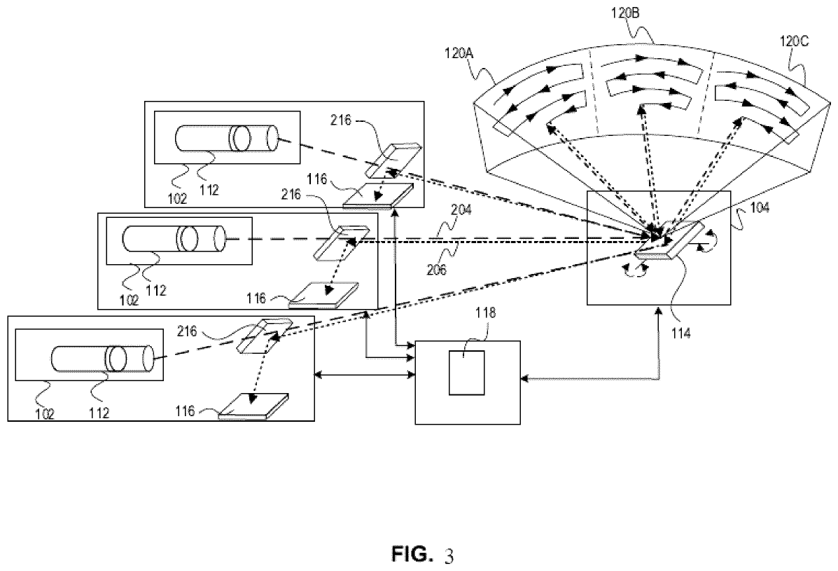

Consistent with disclosed embodiments, the LIDAR system may include at least one projecting unit with a light source configured to project light. As used herein the term “light source” broadly refers to any device configured to emit light. In one embodiment, the light source may be a laser such as a solid-state laser, laser diode, a high power laser, or an alternative light source such as, a light emitting diode (LED)-based light source. In addition, light source 112 as illustrated throughout the figures, may emit light in differing formats, such as light pulses, continuous wave (CW), quasi-CW, and so on. For example, one type of light source that may be used is a vertical-cavity surface-emitting laser (VCSEL). Another type of light source that may be used is an external cavity diode laser (ECDL). In some examples, the light source may include a laser diode configured to emit light at a wavelength between about 650 nm and 1150 nm. Alternatively, the light source may include a laser diode configured to emit light at a wavelength between about 800 nm and about 1000 nm, between about 850 nm and about 950 nm, or between about 1300 nm and about 1600 nm. Unless indicated otherwise, the term “about” with regards to a numeric value is defined as a variance of up to 5% with respect to the stated value. Additional details on the projecting unit and the at least one light source are described below with reference to FIGS. 2 and 3 of the current application and with reference to FIGS. 2A-2C of PCT patent application PCT/IB2020/055283 publication number WO2020/245767 which is incorporated herein by reference.

Consistent with disclosed embodiments, the LIDAR system may include at least one scanning unit with at least one light deflector configured to deflect light from the light source in order to scan the field of view. The term “light deflector” broadly includes any mechanism or module which is configured to make light deviate from its original path; for example, a mirror, a prism, controllable lens, a mechanical mirror, mechanical scanning polygons, active diffraction (e.g. controllable LCD), Risley prisms, non-mechanical-electro-optical beam steering (such as made by Vscent), polarization grating (such as offered by Boulder Non-Linear Systems), optical phased array (OPA), and more. In one embodiment, a light deflector may include a plurality of optical components, such as at least one reflecting element (e.g. a mirror), at least one refracting element (e.g. a prism, a lens), and so on. In one example, the light deflector may be movable, to cause light deviate to differing degrees (e.g. discrete degrees, or over a continuous span of degrees). The light deflector may optionally be controllable in different ways (e.g. deflect to a degree α, change deflection angle by Δα, move a component of the light deflector by M millimeters, change speed in which the deflection angle changes). In addition, the light deflector may optionally be operable to change an angle of deflection within a single plane (e.g., θ coordinate). The light deflector may optionally be operable to change an angle of deflection within two non-parallel planes (e.g., θ and ϕ coordinates). Alternatively or in addition, the light deflector may optionally be operable to change an angle of deflection between predetermined settings (e.g. along a predefined scanning route) or otherwise. With respect the use of light deflectors in LIDAR systems, it is noted that a light deflector may be used in the outbound direction (also referred to as transmission direction, or TX) to deflect light from the light source to at least a part of the field of view. However, a light deflector may also be used in the inbound direction (also referred to as reception direction, or RX) to deflect light from at least a part of the field of view to one or more light sensors. Additional details on the scanning unit and the at least one light deflector are described below with reference to FIGS. 3A-3C of PCT patent application PCT/IB2020/055283 publication number WO2020/245767 which is incorporated herein by reference.

Disclosed embodiments may involve pivoting the light deflector in order to scan the field of view. As used herein the term “pivoting” broadly includes rotating of an object (especially a solid object) about one or more axis of rotation, while substantially maintaining a center of rotation fixed. In one embodiment, the pivoting of the light deflector may include rotation of the light deflector about a fixed axis (e.g., a shaft), but this is not necessarily so. For example, in some MEMS mirror implementation, the MEMS mirror may move by actuation of a plurality of benders connected to the mirror, the mirror may experience some spatial translation in addition to rotation. Nevertheless, such mirror may be designed to rotate about a substantially fixed axis, and therefore consistent with the present disclosure it considered to be pivoted. In other embodiments, some types of light deflectors (e.g. non-mechanical-electro-optical beam steering, OPA) do not require any moving components or internal movements in order to change the deflection angles of deflected light. It is noted that any discussion relating to moving or pivoting a light deflector is also mutatis mutandis applicable to controlling the light deflector such that it changes a deflection behavior of the light deflector. For example, controlling the light deflector may cause a change in a deflection angle of beams of light arriving from at least one direction.

Disclosed embodiments may involve receiving reflections associated with a portion of the field of view corresponding to a single instantaneous position of the light deflector. As used herein, the term “instantaneous position of the light deflector” (also referred to as “state of the light deflector”) broadly refers to the location or position in space where at least one controlled component of the light deflector is situated at an instantaneous point in time, or over a short span of time. In one embodiment, the instantaneous position of light deflector may be gauged with respect to a frame of reference. The frame of reference may pertain to at least one fixed point in the LIDAR system. Or, for example, the frame of reference may pertain to at least one fixed point in the scene. In some embodiments, the instantaneous position of the light deflector may include some movement of one or more components of the light deflector (e.g. mirror, prism), usually to a limited degree with respect to the maximal degree of change during a scanning of the field of view. For example, a scanning of the entire the field of view of the LIDAR system may include changing deflection of light over a span of 30°, and the instantaneous position of the at least one light deflector may include angular shifts of the light deflector within 0.05°. In other embodiments, the term “instantaneous position of the light deflector” may refer to the positions of the light deflector during acquisition of light which is processed to provide data for a single point of a point cloud (or another type of 3D model) generated by the LIDAR system. In some embodiments, an instantaneous position of the light deflector may correspond with a fixed position or orientation in which the deflector pauses for a short time during illumination of a particular sub-region of the LIDAR field of view. In other cases, an instantaneous position of the light deflector may correspond with a certain position/orientation along a scanned range of positions/orientations of the light deflector that the light deflector passes through as part of a continuous or semi-continuous scan of the LIDAR field of view. In some embodiments, the light deflector may be moved such that during a scanning cycle of the LIDAR FOV the light deflector is located at a plurality of different instantaneous positions. In other words, during the period of time in which a scanning cycle occurs, the deflector may be moved through a series of different instantaneous positions/orientations, and the deflector may reach each different instantaneous position/orientation at a different time during the scanning cycle.

Consistent with disclosed embodiments, the LIDAR system may include at least one sensing unit with at least one sensor configured to detect reflections from objects in the field of view. The term “sensor” broadly includes any device, element, or system capable of measuring properties (e.g., power, frequency, phase, pulse timing, pulse duration) of electromagnetic waves and to generate an output relating to the measured properties. In some embodiments, the at least one sensor may include a plurality of detectors constructed from a plurality of detecting elements. The at least one sensor may include light sensors of one or more types. It is noted that the at least one sensor may include multiple sensors of the same type which may differ in other characteristics (e.g., sensitivity, size). Other types of sensors may also be used. Combinations of several types of sensors can be used for different reasons, such as improving detection over a span of ranges (especially in close range); improving the dynamic range of the sensor; improving the temporal response of the sensor; and improving detection in varying environmental conditions (e.g. atmospheric temperature, rain, etc.).

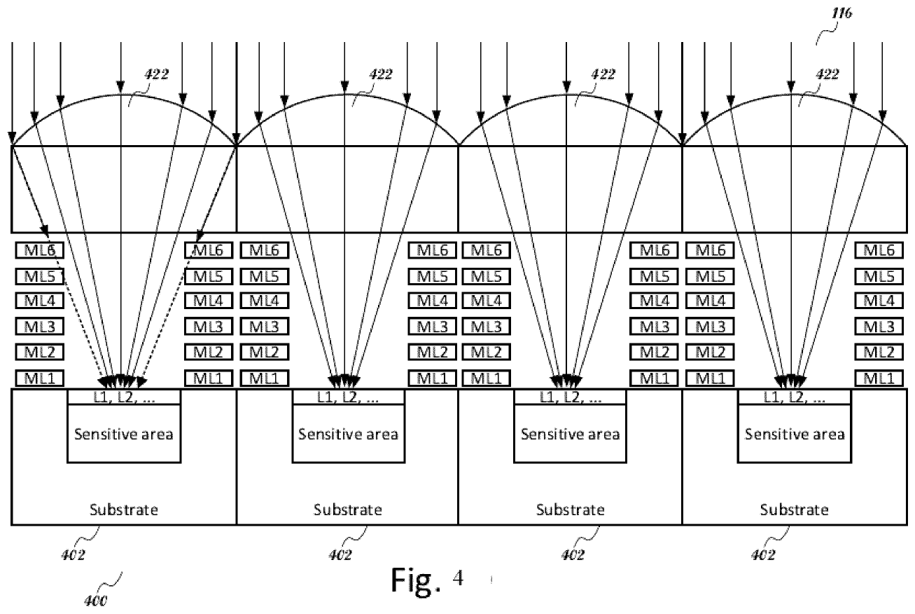

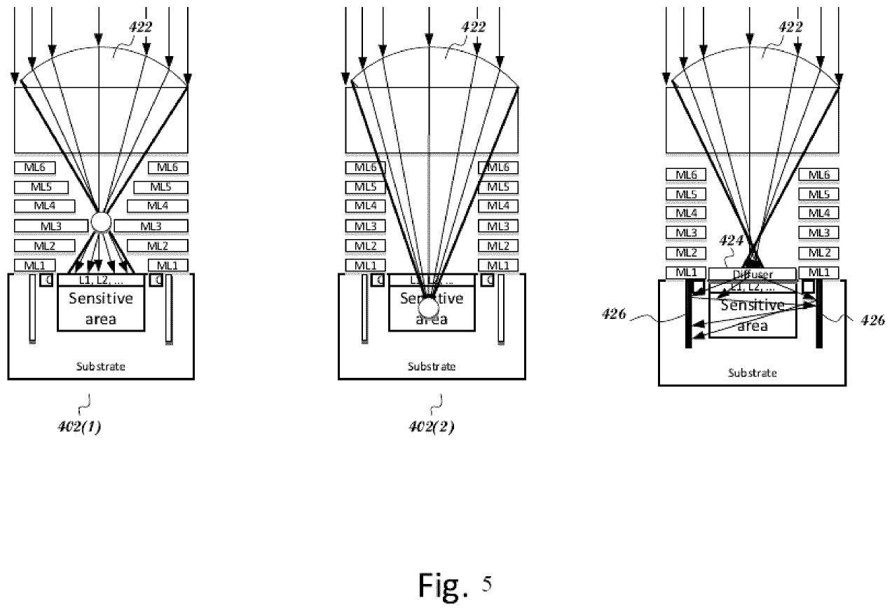

In one embodiment, the at least one sensor includes a SiPM (Silicon photomultipliers) which is a solid-state single-photon-sensitive device built from an array of avalanche photodiode (APD), single photon avalanche diode (SPAD), serving as detection elements on a common silicon substrate. In one example, a typical distance between SPADs may be between about 10 μm and about 50 μm, wherein each SPAD may have a recovery time of between about 20 ns and about 100 ns. Similar photomultipliers from other, non-silicon materials may also be used. Although a SiPM device works in digital/switching mode, the SiPM is an analog device because all the microcells may be read in parallel, making it possible to generate signals within a dynamic range from a single photon to hundreds and thousands of photons detected by the different SPADs. It is noted that outputs from different types of sensors (e.g., SPAD, APD, SiPM, PIN diode, Photodetector) may be combined together to a single output which may be processed by a processor of the LIDAR system. Additional details on the sensing unit and the at least one sensor are described below with reference to FIGS. 4 and 5 of the current application and with reference to FIGS. 4A-4C of PCT patent application PCT/IB2020/055283 publication number WO2020/245767 which is incorporated herein by reference.

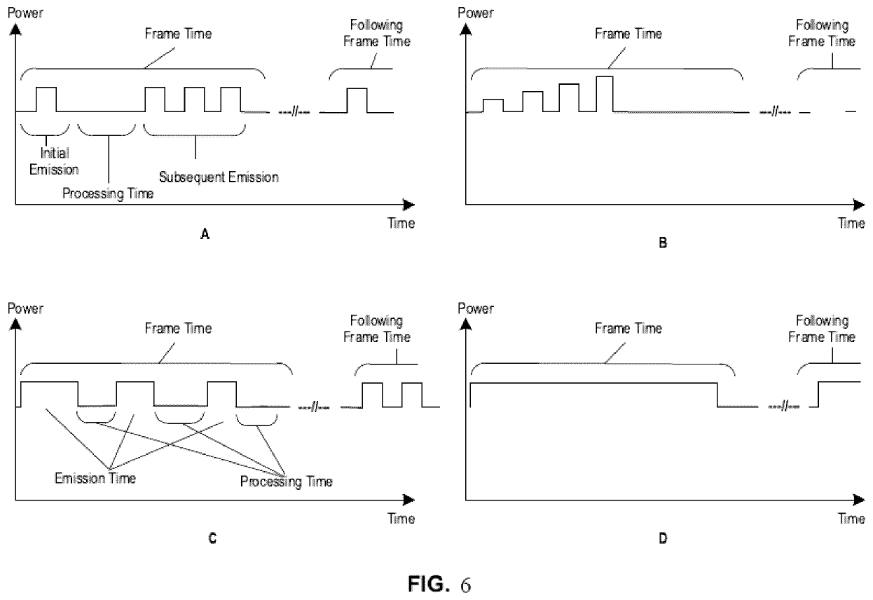

Consistent with disclosed embodiments, the LIDAR system may include or communicate with at least one processor configured to execute differing functions. The at least one processor may constitute any physical device having an electric circuit that performs a logic operation on input or inputs. For example, the at least one processor may include one or more integrated circuits (IC), including Application-specific integrated circuit (ASIC), microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The instructions executed by at least one processor may, for example, be pre-loaded into a memory integrated with or embedded into the controller or may be stored in a separate memory. The memory may comprise a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the memory is configured to store information representative data about objects in the environment of the LIDAR system. In some embodiments, the at least one processor may include more than one processor. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically or by other means that permit them to interact. Additional details on the processing unit and the at least one processor are described below with reference to FIG. 6 of the current application and with reference to FIGS. 5A-5C of PCT patent application PCT/IB2020/055283 publication number WO2020/245767 which is incorporated herein by reference.

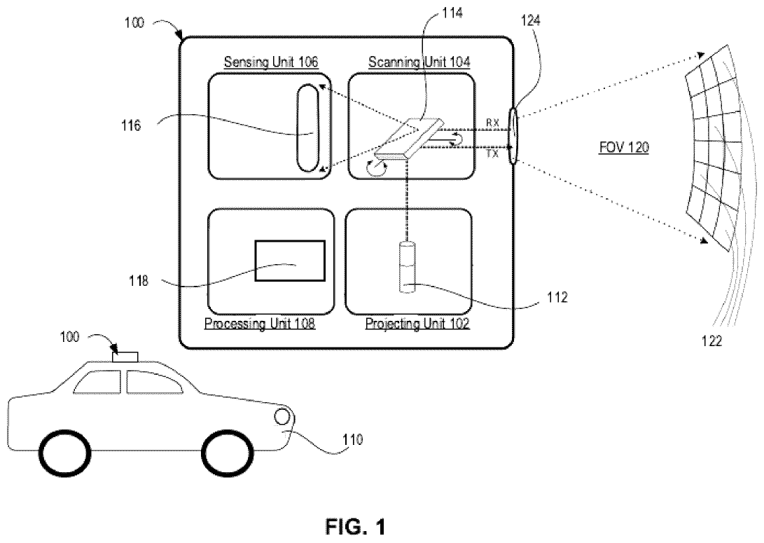

FIG. 1 illustrates a LIDAR system 100 including a projecting unit 102, a scanning unit 104, a sensing unit 106, and a processing unit 108. LIDAR system 100 may be mountable on a vehicle 110. Consistent with embodiments of the present disclosure, projecting unit 102 may include at least one light source 112, scanning unit 104 may include at least one light deflector 114, sensing unit 106 may include at least one sensor 116, and processing unit 108 may include at least one processor 118. In one embodiment, at least one processor 118 may be configured to coordinate operation of the at least one light source 112 with the movement of at least one light deflector 114 in order to scan a field of view 120. During a scanning cycle, each instantaneous position of at least one light deflector 114 may be associated with a particular portion 122 of field of view 120. In addition, LIDAR system 100 may include at least one optional optical window 124 for directing light projected towards field of view 120 and/or receiving light reflected from objects in field of view 120. Optional optical window 124 may serve different purposes, such as collimation of the projected light and focusing of the reflected light. In one embodiment, optional optical window 124 may be an opening, a flat window, a lens, or any other type of optical window.

Consistent with the present disclosure, LIDAR system 100 may be used in autonomous or semi-autonomous road-vehicles (for example, cars, buses, vans, trucks and any other terrestrial vehicle). Autonomous road-vehicles with LIDAR system 100 may scan their environment and drive to a destination vehicle without human input. Similarly, LIDAR system 100 may also be used in autonomous/semi-autonomous aerial-vehicles (for example, UAV, drones, quadcopters, and any other airborne vehicle or device); or in an autonomous or semi-autonomous water vessel (e.g., boat, ship, submarine, or any other watercraft). Autonomous aerial-vehicles and water craft with LIDAR system 100 may scan their environment and navigate to a destination autonomously or using a remote human operator. According to one embodiment, vehicle 110 (either a road-vehicle, aerial-vehicle, or watercraft) may use LIDAR system 100 to aid in detecting and scanning the environment in which vehicle 110 is operating.

It should be noted that LIDAR system 100 or any of its components may be used together with any of the example embodiments and methods disclosed herein. Further, while some aspects of LIDAR system 100 are described relative to an exemplary vehicle-based LIDAR platform, LIDAR system 100, any of its components, or any of the processes described herein may be applicable to LIDAR systems of other platform types.

In some embodiments, LIDAR system 100 may include one or more scanning units 104 to scan the environment around vehicle 110. LIDAR system 100 may be attached or mounted to any part of vehicle 110. Sensing unit 106 may receive reflections from the surroundings of vehicle 110, and transfer reflections signals indicative of light reflected from objects in field of view 120 to processing unit 108. Consistent with the present disclosure, scanning units 104 may be mounted to or incorporated into a bumper, a fender, a side panel, a spoiler, a roof, a headlight assembly, a taillight assembly, a rear-view mirror assembly, a hood, a trunk or any other suitable part of vehicle 110 capable of housing at least a portion of the LIDAR system. In some cases, LIDAR system 100 may capture a complete surround view of the environment of vehicle 110. Thus, LIDAR system 100 may have a 360-degree horizontal field of view. In one example, as shown in FIG. 1, LIDAR system 100 may include a single scanning unit 104 mounted on a roof vehicle 110. Alternatively, LIDAR system 100 may include multiple scanning units (e.g., two, three, four, or more scanning units 104) each with a field of few such that in the aggregate the horizontal field of view is covered by a 360-degree scan around vehicle 110. One skilled in the art will appreciate that LIDAR system 100 may include any number of scanning units 104 arranged in any manner, each with an 80° to 120° field of view or less, depending on the number of units employed. Moreover, a 360-degree horizontal field of view may be also obtained by mounting a multiple LIDAR systems 100 on vehicle 110, each with a single scanning unit 104. It is nevertheless noted that the one or more LIDAR systems 100 do not have to provide a complete 360° field of view, and that narrower fields of view may be useful in some situations. For example, vehicle 110 may require a first LIDAR system 100 having a field of view of 75° looking ahead of the vehicle, and possibly a second LIDAR system 100 with a similar FOV looking backward (optionally with a lower detection range). It is also noted that different vertical field of view angles may also be implemented.

The Projecting Unit

FIGS. 2 and 3 depict various configurations of projecting unit 102 and its role in LIDAR system 100. Specifically, FIG. 2 is a diagram illustrating projecting unit 102 with a single light source; FIG. 3 is a diagram illustrating a plurality of projecting units 102 with a plurality of light sources aimed at a common light deflector 114. One skilled in the art will appreciate that the depicted configurations of projecting unit 102 may have numerous variations and modifications. Non limiting examples are provided in FIGS. 2C-2G of PCT patent application PCT/IB2020/055283 publication number WO2020/245767 which is incorporated herein by reference.

FIG. 2 illustrates an example of a bi-static configuration of LIDAR system 100 in which projecting unit 102 includes a single light source 112. The term “bi-static configuration” broadly refers to LIDAR systems configurations in which the projected light exiting the LIDAR system and the reflected light entering the LIDAR system pass through substantially different optical paths. In some embodiments, a bi-static configuration of LIDAR system 100 may include a separation of the optical paths by using completely different optical components, by using parallel but not fully separated optical components, or by using the same optical components for only part of the of the optical paths (optical components may include, for example, windows, lenses, mirrors, beam splitters, etc.). In the example depicted in FIG. 2A, the bi-static configuration includes a configuration where the outbound light and the inbound light pass through a single optical window 124 but scanning unit 104 includes two light deflectors, a first light deflector 114A for outbound light and a second light deflector 114B for inbound light (the inbound light in LIDAR system includes emitted light reflected from objects in the scene, and may also include ambient light arriving from other sources).

In this embodiment, all the components of LIDAR system 100 may be contained within a single housing 200, or may be divided among a plurality of housings. As shown, projecting unit 102 is associated with a single light source 112 that includes a laser diode 202A (or one or more laser diodes coupled together) configured to emit light (projected light 204). In one non-limiting example, the light projected by light source 112 may be at a wavelength between about 800 nm and 950 nm, have an average power between about 50 mW and about 500 mW, have a peak power between about 50 W and about 200 W, and a pulse width of between about 2 ns and about 100 ns. In addition, light source 112 may optionally be associated with optical assembly 202B used for manipulation of the light emitted by laser diode 202A (e.g. for collimation, focusing, etc.). It is noted that other types of light sources 112 may be used, and that the disclosure is not restricted to laser diodes. In addition, light source 112 may emit its light in different formats, such as light pulses, frequency modulated, continuous wave (CW), quasi-CW, or any other form corresponding to the particular light source employed. The projection format and other parameters may be changed by the light source from time to time based on different factors, such as instructions from processing unit 108. The projected light is projected towards an outbound deflector 114A that functions as a steering element for directing the projected light in field of view 120. In this example, scanning unit 104 also include a pivotable return deflector 114B that direct photons (reflected light 206) reflected back from an object 208 within field of view 120 toward sensor 116. The reflected light is detected by sensor 116 and information about the object (e.g., the distance to object 212) is determined by processing unit 108.

In this figure, LIDAR system 100 is connected to a host 210. Consistent with the present disclosure, the term “host” refers to any computing environment that may interface with LIDAR system 100, it may be a vehicle system (e.g., part of vehicle 110), a testing system, a security system, a surveillance system, a traffic control system, an urban modelling system, or any system that monitors its surroundings. Such computing environment may include at least one processor and/or may be connected LIDAR system 100 via the cloud. In some embodiments, host 210 may also include interfaces to external devices such as camera and sensors configured to measure different characteristics of host 210 (e.g., acceleration, steering wheel deflection, reverse drive, etc.). Consistent with the present disclosure, LIDAR system 100 may be fixed to a stationary object associated with host 210 (e.g. a building, a tripod) or to a portable system associated with host 210 (e.g., a portable computer, a movie camera). Consistent with the present disclosure, LIDAR system 100 may be connected to host 210, to provide outputs of LIDAR system 100 (e.g., a 3D model, a reflectivity image) to host 210. Specifically, host 210 may use LIDAR system 100 to aid in detecting and scanning the environment of host 210 or any other environment. In addition, host 210 may integrate, synchronize or otherwise use together the outputs of LIDAR system 100 with outputs of other sensing systems (e.g. cameras, microphones, radar systems). In one example, LIDAR system 100 may be used by a security system.

LIDAR system 100 may also include a bus 212 (or other communication mechanisms) that interconnect subsystems and components for transferring information within LIDAR system 100. Optionally, bus 212 (or another communication mechanism) may be used for interconnecting LIDAR system 100 with host 210. In the example of FIG. 2A, processing unit 108 includes two processors 118 to regulate the operation of projecting unit 102, scanning unit 104, and sensing unit 106 in a coordinated manner based, at least partially, on information received from internal feedback of LIDAR system 100. In other words, processing unit 108 may be configured to dynamically operate LIDAR system 100 in a closed loop. A closed loop system is characterized by having feedback from at least one of the elements and updating one or more parameters based on the received feedback. Moreover, a closed loop system may receive feedback and update its own operation, at least partially, based on that feedback. A dynamic system or element is one that may be updated during operation.

According to some embodiments, scanning the environment around LIDAR system 100 may include illuminating field of view 120 with light pulses. The light pulses may have parameters such as: pulse duration, pulse angular dispersion, wavelength, instantaneous power, photon density at different distances from light source 112, average power, pulse power intensity, pulse width, pulse repetition rate, pulse sequence, pulse duty cycle, wavelength, phase, polarization, and more. Scanning the environment around LIDAR system 100 may also include detecting and characterizing various aspects of the reflected light. Characteristics of the reflected light may include, for example: time-of-flight (i.e., time from emission until detection), instantaneous power (e.g., power signature), average power across entire return pulse, and photon distribution/signal over return pulse period. By comparing characteristics of a light pulse with characteristics of corresponding reflections, a distance and possibly a physical characteristic, such as reflected intensity of object 212 may be estimated. By repeating this process across multiple adjacent portions 122, in a predefined pattern (e.g., raster, Lissajous or other patterns) an entire scan of field of view 120 may be achieved. As discussed below in greater detail, in some situations LIDAR system 100 may direct light to only some of the portions 122 in field of view 120 at every scanning cycle. These portions may be adjacent to each other, but not necessarily so.

In another embodiment, LIDAR system 100 may include network interface 214 for communicating with host 210 (e.g., a vehicle controller). The communication between LIDAR system 100 and host 210 is represented by a dashed arrow. In one embodiment, network interface 214 may include an integrated services digital network (ISDN) card, cable modem, satellite modem, or a modem to provide a data communication connection to a corresponding type of telephone line. As another example, network interface 214 may include a local area network (LAN) card to provide a data communication connection to a compatible LAN. In another embodiment, network interface 214 may include an Ethernet port connected to radio frequency receivers and transmitters and/or optical (e.g., infrared) receivers and transmitters. The specific design and implementation of network interface 214 depends on the communications network(s) over which LIDAR system 100 and host 210 are intended to operate. For example, network interface 214 may be used, for example, to provide outputs of LIDAR system 100 to the external system, such as a 3D model, operational parameters of LIDAR system 100, and so on. In other embodiment, the communication unit may be used, for example, to receive instructions from the external system, to receive information regarding the inspected environment, to receive information from another sensor, etc.

FIG. 3 illustrates an example of a monostatic configuration of LIDAR system 100 including a plurality projecting units 102. The term “monostatic configuration” broadly refers to LIDAR system configurations in which the projected light exiting from the LIDAR system and the reflected light entering the LIDAR system pass through substantially similar optical paths. In one example, the outbound light beam and the inbound light beam may share at least one optical assembly through which both outbound and inbound light beams pass. In another example, the outbound light may pass through an optical window (not shown) and the inbound light radiation may pass through the same optical window. A monostatic configuration may include a configuration where the scanning unit 104 includes a single light deflector 114 that directs the projected light towards field of view 120 and directs the reflected light towards a sensor 116. As shown, both projected light 204 and reflected light 206 hits an asymmetrical deflector 216. The term “asymmetrical deflector” refers to any optical device having two sides capable of deflecting a beam of light hitting it from one side in a different direction than it deflects a beam of light hitting it from the second side. In one example, the asymmetrical deflector does not deflect projected light 204 and deflects reflected light 206 towards sensor 116. One example of an asymmetrical deflector may include a polarization beam splitter. In another example, asymmetrical 216 may include an optical isolator that allows the passage of light in only one direction. A diagrammatic representation of asymmetrical deflector 216 is illustrated in FIG. 2D. Consistent with the present disclosure, a monostatic configuration of LIDAR system 100 may include an asymmetrical deflector to prevent reflected light from hitting light source 112, and to direct all the reflected light toward sensor 116, thereby increasing detection sensitivity.

In the embodiment of FIG. 3, LIDAR system 100 includes three projecting units 102 each with a single of light source 112 aimed at a common light deflector 114. In one embodiment, the plurality of light sources 112 (including two or more light sources) may project light with substantially the same wavelength and each light source 112 is generally associated with a differing area of the field of view (denoted in the figure as 120A, 120B, and 120C). This enables scanning of a broader field of view than can be achieved with a light source 112. In another embodiment, the plurality of light sources 102 may project light with differing wavelengths, and all the light sources 112 may be directed to the same portion (or overlapping portions) of field of view 120.

### The Sensing Unit

FIGS. 4 and 5 depict various configurations of sensing unit 106 and its role in LIDAR system 100. Specifically, FIG. 4 is a diagram illustrating a lens array associated with sensor 116, and FIG. 5 includes three diagram illustrating the lens structure. One skilled in the art will appreciate that the depicted configurations of sensing unit 106 are exemplary only and may have numerous alternative variations and modifications consistent with the principles of this disclosure.

FIG. 4 is a cross cut diagram of a part of sensor 116, in accordance with examples of the presently disclosed subject matter. The illustrated part of sensor 116 includes a part of a detector array 400 which includes four detection elements 402 (e.g., four SPADs, four APDs). Detector array 400 may be a photodetector sensor realized in complementary metal-oxide-semiconductor (CMOS). Each of the detection elements 402 has a sensitive area, which is positioned within a substrate surrounding. While not necessarily so, sensor 116 may be used in a monostatic LIDAR system having a narrow field of view (e.g., because scanning unit 104 scans different parts of the field of view at different times). The narrow field of view for the incoming light beam—if implemented—eliminates the problem of out-of-focus imaging. As exemplified in FIG. 4, sensor 116 may include a plurality of lenses 422 (e.g., microlenses), each lens 422 may direct incident light toward a different detection element 402 (e.g., toward an active area of detection element 402), which may be usable when out-of-focus imaging is not an issue. Lenses 422 may be used for increasing an optical fill factor and sensitivity of detector array 400, because most of the light that reaches sensor 116 may be deflected toward the active areas of detection elements 402

Detector array 400, as exemplified in FIG. 4, may include several layers built into the silicon substrate by various methods (e.g., implant) resulting in a sensitive area, contact elements to the metal layers and isolation elements (e.g., shallow trench implant STI, guard rings, optical trenches, etc.). The sensitive area may be a volumetric element in the CMOS detector that enables the optical conversion of incoming photons into a current flow given an adequate voltage bias is applied to the device. In the case of an APD/SPAD, the sensitive area would be a combination of an electrical field that pulls electrons created by photon absorption towards a multiplication area where a photon induced electron is amplified creating a breakdown avalanche of multiplied electrons.

A front side illuminated detector (e.g., as illustrated in FIG. 4) has the input optical port at the same side as the metal layers residing on top of the semiconductor (Silicon). The metal layers are required to realize the electrical connections of each individual photodetector element (e.g., anode and cathode) with various elements such as: bias voltage, quenching/ballast elements, and other photodetectors in a common array. The optical port through which the photons impinge upon the detector sensitive area is comprised of a passage through the metal layer. It is noted that passage of light from some directions through this passage may be blocked by one or more metal layers (e.g., metal layer ML6, as illustrated for the leftmost detector elements 402 in FIG. 4). Such blockage reduces the total optical light absorbing efficiency of the detector.

FIG. 5 illustrates three detection elements 402, each with an associated lens 422, in accordance with examples of the presenting disclosed subject matter. Each of the three detection elements of FIG. 5, denoted 402(1), 402(2), and 402(3), illustrates a lens configuration which may be implemented in associated with one or more of the detecting elements 402 of sensor 116. It is noted that combinations of these lens configurations may also be implemented.

In the lens configuration illustrated with regards to detection element 402(1), a focal point of the associated lens 422 may be located above the semiconductor surface. Optionally, openings in different metal layers of the detection element may have different sizes aligned with the cone of focusing light generated by the associated lens 422. Such a structure may improve the signal-to-noise and resolution of the array 400 as a whole device. Large metal layers may be important for delivery of power and ground shielding. This approach may be useful, e.g., with a monostatic LIDAR design with a narrow field of view where the incoming light beam is comprised of parallel rays and the imaging focus does not have any consequence to the detected signal.

In the lens configuration illustrated with regards to detection element 402(2), an efficiency of photon detection by the detection elements 402 may be improved by identifying a sweet spot. Specifically, a photodetector implemented in CMOS may have a sweet spot in the sensitive volume area where the probability of a photon creating an avalanche effect is the highest. Therefore, a focal point of lens 422 may be positioned inside the sensitive volume area at the sweet spot location, as demonstrated by detection elements 402(2). The lens shape and distance from the focal point may take into account the refractive indices of all the elements the laser beam is passing along the way from the lens to the sensitive sweet spot location buried in the semiconductor material.

In the lens configuration illustrated with regards to the detection element on the right of FIG. 5, an efficiency of photon absorption in the semiconductor material may be improved using a diffuser and reflective elements. Specifically, a near IR wavelength requires a significantly long path of silicon material in order to achieve a high probability of absorbing a photon that travels through. In a typical lens configuration, a photon may traverse the sensitive area and may not be absorbed into a detectable electron. A long absorption path that improves the probability for a photon to create an electron renders the size of the sensitive area towards less practical dimensions (tens of um for example) for a CMOS device fabricated with typical foundry processes. The rightmost detector element in FIG. 5 demonstrates a technique for processing incoming photons. The associated lens 422 focuses the incoming light onto a diffuser element 424. In one embodiment, light sensor 116 may further include a diffuser located in the gap distant from the outer surface of at least some of the detectors. For example, diffuser 424 may steer the light beam sideways (e.g., as perpendicular as possible) towards the sensitive area and the reflective optical trenches 426. The diffuser is located at the focal point, above the focal point, or below the focal point. In this embodiment, the incoming light may be focused on a specific location where a diffuser element is located. Optionally, detector element 422 is designed to optically avoid the inactive areas where a photon induced electron may get lost and reduce the effective detection efficiency. Reflective optical trenches 426 (or other forms of optically reflective structures) cause the photons to bounce back and forth across the sensitive area, thus increasing the likelihood of detection. Ideally, the photons will get trapped in a cavity consisting of the sensitive area and the reflective trenches indefinitely until the photon is absorbed and creates an electron/hole pair.

Consistent with the present disclosure, a long path is created for the impinging photons to be absorbed and contribute to a higher probability of detection. Optical trenches may also be implemented in detecting element 422 for reducing cross talk effects of parasitic photons created during an avalanche that may leak to other detectors and cause false detection events. According to some embodiments, a photo detector array may be optimized so that a higher yield of the received signal is utilized, meaning, that as much of the received signal is received and less of the signal is lost to internal degradation of the signal. The photo detector array may be improved by: (a) moving the focal point at a location above the semiconductor surface, optionally by designing the metal layers above the substrate appropriately; (b) by steering the focal point to the most responsive/sensitive area (or “sweet spot”) of the substrate and (c) adding a diffuser above the substrate to steer the signal toward the “sweet spot” and/or adding reflective material to the trenches so that deflected signals are reflected back to the “sweet spot.”

While in some lens configurations, lens 422 may be positioned so that its focal point is above a center of the corresponding detection element 402, it is noted that this is not necessarily so. In other lens configuration, a position of the focal point of the lens 422 with respect to a center of the corresponding detection element 402 is shifted based on a distance of the respective detection element 402 from a center of the detection array 400. This may be useful in relatively larger detection arrays 400, in which detector elements further from the center receive light in angles which are increasingly off-axis. Shifting the location of the focal points (e.g., toward the center of detection array 400) allows correcting for the incidence angles. Specifically, shifting the location of the focal points (e.g., toward the center of detection array 400) allows correcting for the incidence angles while using substantially identical lenses 422 for all detection elements, which are positioned at the same angle with respect to a surface of the detector.

Adding an array of lenses 422 to an array of detection elements 402 may be useful when using a relatively small sensor 116 which covers only a small part of the field of view because in such a case, the reflection signals from the scene reach the detectors array 400 from substantially the same angle, and it is, therefore, easy to focus all the light onto individual detectors. It is also noted, that in one embodiment, lenses 422 may be used in LIDAR system 100 for favoring about increasing the overall probability of detection of the entire array 400 (preventing photons from being “wasted” in the dead area between detectors/sub-detectors) at the expense of spatial distinctiveness. This embodiment is in contrast to prior art implementations such as CMOS RGB camera, which prioritize spatial distinctiveness (i.e., light that propagates in the direction of detection element A is not allowed to be directed by the lens toward detection element B, that is, to “bleed” to another detection element of the array). Optionally, sensor 116 includes an array of lens 422, each being correlated to a corresponding detection element 402, while at least one of the lenses 422 deflects light which propagates to a first detection element 402 toward a second detection element 402 (thereby it may increase the overall probability of detection of the entire array).

Specifically, consistent with some embodiments of the present disclosure, light sensor 116 may include an array of light detectors (e.g., detector array 400), each light detector (e.g., detector 410) being configured to cause an electric current to flow when light passes through an outer surface of a respective detector. In addition, light sensor 116 may include at least one micro-lens configured to direct light toward the array of light detectors, the at least one micro-lens having a focal point. Light sensor 116 may further include at least one layer of conductive material interposed between the at least one micro-lens and the array of light detectors and having a gap therein to permit light to pass from the at least one micro-lens to the array, the at least one layer being sized to maintain a space between the at least one micro-lens and the array to cause the focal point (e.g., the focal point may be a plane) to be located in the gap, at a location spaced from the detecting surfaces of the array of light detectors.

In related embodiments, each detector may include a plurality of Single Photon Avalanche Diodes (SPADs) or a plurality of Avalanche Photo Diodes (APD). The conductive material may be a multi-layer metal constriction, and the at least one layer of conductive material may be electrically connected to detectors in the array. In one example, the at least one layer of conductive material includes a plurality of layers. In addition, the gap may be shaped to converge from the at least one micro-lens toward the focal point, and to diverge from a region of the focal point toward the array. In other embodiments, light sensor 116 may further include at least one reflector adjacent each photo detector. In one embodiment, a plurality of micro-lenses may be arranged in a lens array and the plurality of detectors may be arranged in a detector array. In another embodiment, the plurality of micro-lenses may include a single lens configured to project light to a plurality of detectors in the array.

### The Processing Unit

FIG. 6 illustrates four examples of emission patterns in a single frame-time for a single portion 122 of field of view 120 associated with an instantaneous position of at least one light deflector 114. Consistent with embodiments of the present disclosure, processing unit 108 may control at least one light source 112 and light deflector 114 (or coordinate the operation of at least one light source 112 and at least one light deflector 114) in a manner enabling light flux to vary over a scan of field of view 120. Consistent with other embodiments, processing unit 108 may control only at least one light source 112 and light deflector 114 may be moved or pivoted in a fixed predefined pattern.

Diagrams A-D in FIG. 6 depict the power of light emitted towards a single portion 122 of field of view 120 over time. In Diagram A, processor 118 may control the operation of light source 112 in a manner such that during scanning of field of view 120 an initial light emission is projected toward portion 122 of field of view 120. When projecting unit 102 includes a pulsed-light light source, the initial light emission may include one or more initial pulses (also referred to as “pilot pulses”). Processing unit 108 may receive from sensor 116 pilot information about reflections associated with the initial light emission. In one embodiment, the pilot information may be represented as a single signal based on the outputs of one or more detectors (e.g. one or more SPADs, one or more APDs, one or more SiPMs, etc.) or as a plurality of signals based on the outputs of multiple detectors. In one example, the pilot information may include analog and/or digital information. In another example, the pilot information may include a single value and/or a plurality of values (e.g. for different times and/or parts of the segment).

Based on information about reflections associated with the initial light emission, processing unit 108 may be configured to determine the type of subsequent light emission to be projected towards portion 122 of field of view 120. The determined subsequent light emission for the particular portion of field of view 120 may be made during the same scanning cycle (i.e., in the same frame) or in a subsequent scanning cycle (i.e., in a subsequent frame).

In Diagram B, processor 118 may control the operation of light source 112 in a manner such that during scanning of field of view 120 light pulses in different intensities are projected towards a single portion 122 of field of view 120. In one embodiment, LIDAR system 100 may be operable to generate depth maps of one or more different types, such as any one or more of the following types: point cloud model, polygon mesh, depth image (holding depth information for each pixel of an image or of a 2D array), or any other type of 3D model of a scene. The sequence of depth maps may be a temporal sequence, in which different depth maps are generated at a different time. Each depth map of the sequence associated with a scanning cycle (interchangeably “frame”) may be generated within the duration of a corresponding subsequent frame-time. In one example, a typical frame-time may last less than a second. In some embodiments, LIDAR system 100 may have a fixed frame rate (e.g. 10 frames per second, 25 frames per second, 50 frames per second) or the frame rate may be dynamic. In other embodiments, the frame-times of different frames may not be identical across the sequence. For example, LIDAR system 100 may implement a 10 frames-per-second rate that includes generating a first depth map in 100 milliseconds (the average), a second frame in 92 milliseconds, a third frame at 142 milliseconds, and so on.

In Diagram C, processor 118 may control the operation of light source 112 in a manner such that during scanning of field of view 120 light pulses associated with different durations are projected towards a single portion 122 of field of view 120. In one embodiment, LIDAR system 100 may be operable to generate a different number of pulses in each frame. The number of pulses may vary between 0 to 32 pulses (e.g., 1, 5, 12, 28, or more pulses) and may be based on information derived from previous emissions. The time between light pulses may depend on desired detection range and can be between 500 ns and 5000 ns. In one example, processing unit 108 may receive from sensor 116 information about reflections associated with each light-pulse. Based on the information (or the lack of information), processing unit 108 may determine if additional light pulses are needed. It is noted that the durations of the processing times and the emission times in diagrams A-D are not in-scale. Specifically, the processing time may be substantially longer than the emission time. In diagram D, projecting unit 102 may include a continuous-wave light source. In one embodiment, the initial light emission may include a period of time where light is emitted and the subsequent emission may be a continuation of the initial emission, or there may be a discontinuity. In one embodiment, the intensity of the continuous emission may change over time.

Consistent with some embodiments of the present disclosure, the emission pattern may be determined per each portion of field of view 120. In other words, processor 118 may control the emission of light to allow differentiation in the illumination of different portions of field of view 120. In one example, processor 118 may determine the emission pattern for a single portion 122 of field of view 120, based on detection of reflected light from the same scanning cycle (e.g., the initial emission), which makes LIDAR system 100 extremely dynamic. In another example, processor 118 may determine the emission pattern for a single portion 122 of field of view 120, based on detection of reflected light from a previous scanning cycle. The differences in the patterns of the subsequent emissions may result from determining different values for light-source parameters for the subsequent emission, such as any one of the following.
a. Overall energy of the subsequent emission.
b. Energy profile of the subsequent emission.
c. A number of light-pulse-repetition per frame.
d. Light modulation characteristics such as duration, rate, peak, average power, and pulse shape.
e. Wave properties of the subsequent emission, such as polarization, wavelength, etc.

Consistent with the present disclosure, the differentiation in the subsequent emissions may be put to different uses. In one example, it is possible to limit emitted power levels in one portion of field of view 120 where safety is a consideration, while emitting higher power levels (thus improving signal-to-noise ratio and detection range) for other portions of field of view 120. This is relevant for eye safety, but may also be relevant for skin safety, safety of optical systems, safety of sensitive materials, and more. In another example, it is possible to direct more energy towards portions of field of view 120 where it will be of greater use (e.g. regions of interest, further distanced targets, low reflection targets, etc.) while limiting the lighting energy to other portions of field of view 120 based on detection results from the same frame or previous frame. It is noted that processing unit 108 may process detected signals from a single instantaneous field of view several times within a single scanning frame time; for example, subsequent emission may be determined upon after every pulse emitted, or after a number of pulses emitted.

It should be noted that while examples of various disclosed embodiments have been described above and below with respect to a control unit that controls scanning of a deflector, the various features of the disclosed embodiments are not limited to such systems. Rather, the techniques for allocating light to various portions of a LIDAR FOV may be applicable to type of light-based sensing system (LIDAR or otherwise) in which there may be a desire or need to direct different amounts of light to different portions of field of view. In some cases, such light allocation techniques may positively impact detection capabilities, as described herein, but other advantages may also result.

It should also be noted that various sections of the disclosure and the claims may refer to various components or portions of components (e.g., light sources, sensors, sensor pixels, field of view portions, field of view pixels, etc.) using such terms as “first,” “second,” “third,” etc. These terms are used only to facilitate the description of the various disclosed embodiments and are not intended to be limiting or to indicate any necessary correlation with similarly named elements or components in other embodiments. For example, characteristics described as associated with a “first sensor” in one described embodiment in one section of the disclosure may or may not be associated with a “first sensor” of a different embodiment described in a different section of the disclosure.

It is noted that LIDAR system 100, or any of its components, may be used together with any of the particular embodiments and methods disclosed below. Nevertheless, the particular embodiments and methods disclosed below are not necessarily limited to LIDAR system 100, and may possibly be implemented in or by other systems (such as but not limited to other LIDAR systems, other electrooptical systems, other optical systems, etc.—whichever is applicable). Also, while system 100 is described relative to an exemplary vehicle-based LIDAR platform, system 100, any of its components, and any of the processes described herein may be applicable to LIDAR systems disposed on other platform types. Likewise, the embodiments and processes disclosed below may be implemented on or by LIDAR systems (or other systems such as other elecrooptical systems etc.) which are installed on systems disposed on platforms other than vehicles, or even regardless of any specific platform.

### Dynamic Alignment of Opto-Mechanical Parts

In the following text there may be references to an array of light beams that form an array of spots. This is a non-limiting example of reflected light. Any reference to an array of light beams that form an array of spots may be applied mutatis mutandis to other forms of reflected light—for example a single light beam and/or a single spot formed on an array of sensing elements. A sensing element may include one or more detection elements such as detection elements 402 of FIG. 4. A sensing element may include an array of detection elements—such as a two dimensional array of detection elements.

Any reference to the term “one or more arrays of reflected light spots” should be applied mutatis mutandis to “array of reflected light beams that form spots” and/or should be applied mutatis mutandis to “reflected light spots”. An array may mean any arrangement of elements—ordered or unordered.

The focal point of a reflected light beam may impinge on a light sensitive region. The impingement on the light sensitive region may be on an outer surface of the light sensitive region on the sweet spot (see reference to the sweet spot in FIGS. 4 and 5). Any reference in the following text to a focus condition may refer to having the focal point impinging on the sweet spot.

The term “misalignment” refers to a spatial deviation of one or more reflected light spots that impinge on one or more sensing elements. The deviation may be a focus deviation—for example—the focal point of the one or more reflected light spots may precede one or more sensing regions of the one or more sensing elements. The deviation may be within a plane of the sensing regions of the one or more sensing elements—for example—up, down, right, left or a combination thereof. The deviation may represent a difference in relation to locations of misalignment free reflected light spots.

The term “dynamic alignment controller” refers to a controller that is configured to detect and/or measure one or more misalignments. The processor may also be configured to at least a partially compensate one or more misalignments.

The term “dynamic” may mean that the alignment may be executed multiple times and/or that the alignment may be executed after the LIDAR is shipped from its manufacturer—for example during operation of the LIDAR.

The automotive industry demands extreme system stability over a wide, challenging range of environmental conditions, including temperature, humidity, vibrations, and shock resistance. Furthermore, lower cost solutions are highly desirable, to preserve the overall cost of the sensor of the vehicle itself. The use of Dynamic Alignment (DA) mechanisms to compensate for performance-degrading misalignments can be advantageous in those areas.

The current disclosure relates to Dynamic Alignment, describes its benefits in the LIDAR industry of autonomous driving and describes its different variations and mechanisms.

Dynamic Alignment is achieved by adding controllable degrees of freedom to elements in the optical path of the LIDAR system, and using them to adjust those elements according to a certain feedback from the system. Different mechanisms may differ by the axes and direction of motion, the actuation mechanism, the actuated elements, the sensor and type of feedback, the compensation methodology (namely, iterative vs pre-calibrated), and whether the compensation can occur either online or offline. Possible variations of each difference will be described ahead, and each combination is legitimate and should be considered independently.

Additionally, Dynamic Alignment can be used to permit extended range of element tolerance during fabrication, and even accelerate the process by reducing accuracy demands, since they can be dynamically readjusted during the operation of the system throughout its lifetime.

### Dynamic Alignment for LIDARs in the Autonomous Driving Industry

Dynamic Alignment (DA) mechanisms fit well in the LIDAR industry of autonomous driving. Challenging operation conditions make the system vulnerable to misalignments that may degrade the system performance. In some cases described below, performance degradation may be critical. Such misalignments must be avoided, and known methods such as active cooling, shock damping, and expensive product materials are not always available within budget and limitations.

Since ambient conditions affect the optical path, Dynamic Alignment can be used to compensate for these effects. It offers robust, active mechanisms that cover a wide range of errors that the system often meets.

Error! Reference source not found. demonstrates a scenario in which a LIDAR can benefit from dynamic alignment. The compensation mechanism realigns the system in response to the misalignment, for example, caused by thermal expansion or other distorted or misaligned elements.

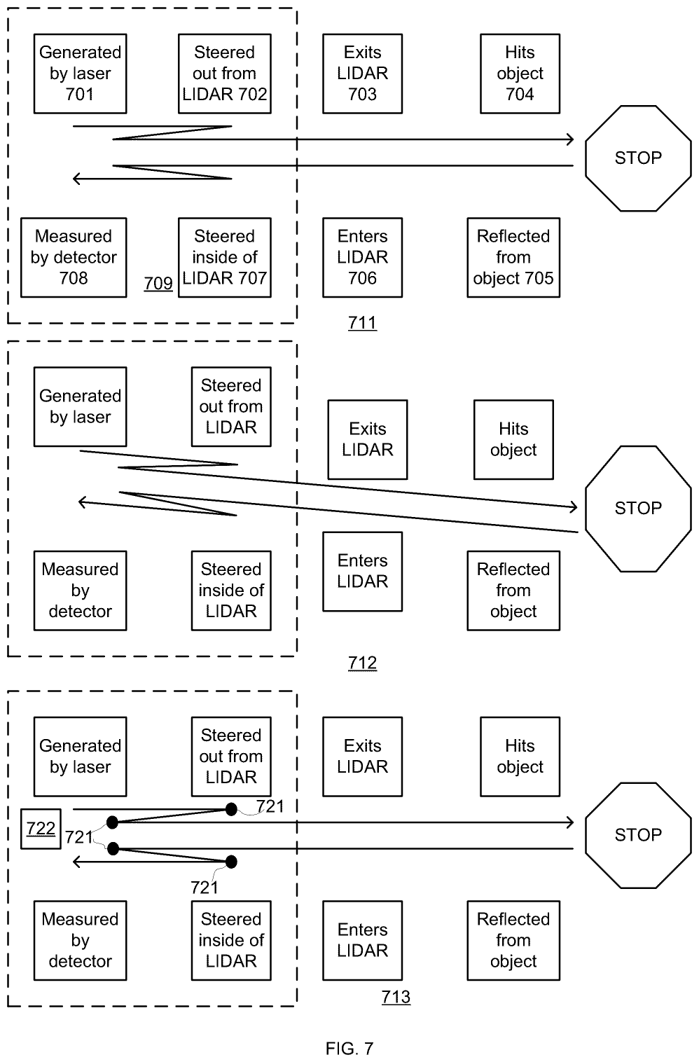

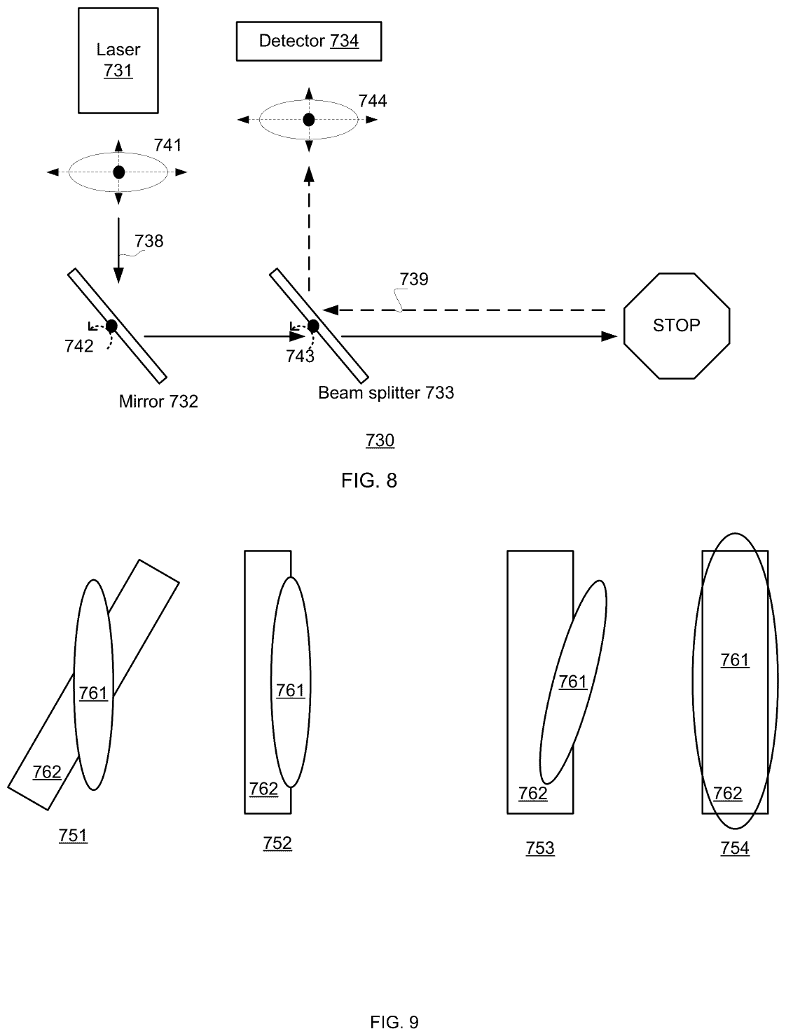

In the top region of FIG. 7, a light beam is generated by laser 701, steered (702) out from the LIDAR, exits (703) the LIDAR (709), and hits (704) an object such as a STOP sign. A reflected light beam is reflected (705) from the object, enters (706) the LIDAR, is steered (707) inside the LIDAR, and measured (708) by a detector.

The center region of FIG. 7 illustrates a misalignment that may deviate (partially or fully) the reflected light beam from the detector (also referred to as TX-RX misalignment).

The lower region of FIG. 7 illustrates a compensation of the misalignment—using compensating elements 721 controlled by processor 722.

Error! Reference source not found. illustrates a conceptual architecture of a LIDAR, with examples of components that can benefit from dynamic alignment. Laser 731 emits an emitted light beam 738. The emitted light beam 738 is reflected from mirror 732 that has a controllable tilt angle (742), the reflected beam is transmitted through beam splitter 733 and impinges upon the object. The reflected light beam (from the object) 739 impinges upon the beam splitter 733 and is directed to detector 734.

The laser 731 can be moved (have its position adjusted) with two degrees of freedom (741). The mirror 732 has a controllable tilt angle (742). The beam splitter has a controllable (743) tilt angle. The detector 734 can be moved with two degrees of freedom (744).

Any other degrees of freedom and/or type of movements may be provided.

FIG. 9 illustrates various misalignments (denoted 751, 752, 753 and 752) in LIDARs and their effect on signal detection. The reflected light beam spot is denoted 761 and a sensing region of a detector is denoted 762. Each of these misalignments may be reduced through dynamic alignment corrections. A beam spot is s shape formed by a light beam when impinging on the sensing region.

Mechanical alignment of opto-mechanical parts can be made by basically moving (translating or rotating) any opto-mechanical part in the system, where the selection of the exact part and degree of freedom depends on the sensitivity analysis to compensate for misalignments. The alignment can be obtained, for example, by moving the sensor, tilting folding mirrors, moving or tilting lenses, shifting the collimator with respect to the laser source, dynamically controlling MEMS mirrors, etc.

### Dynamic Alignment Variations

### Axes of Motion

Optical elements and other components in the optical path that participate in the steering and alignment of emitted beams can be mounted in advance on a controllable actuator, which may readjust their position in the event of a detected degradation. Different elements may actuate different motion types, and such actuators can introduce various combinations of motion types.

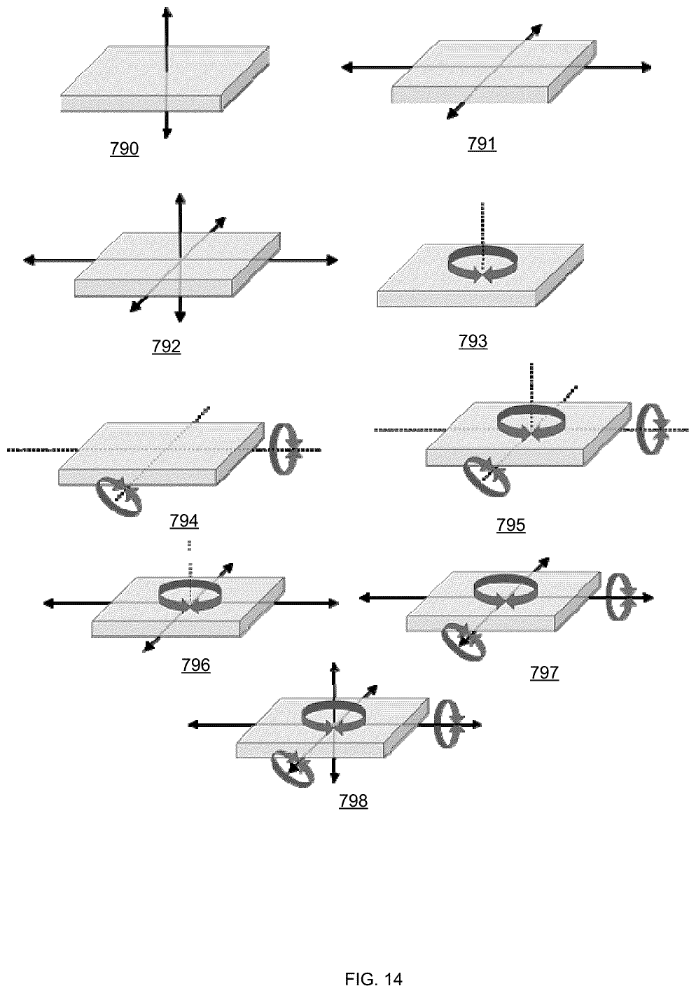

FIG. 14 illustrates example of motion types that can be applied—for example—to compensate for optical unit misalignment—the compensation may be executed by a compensation unit.
a. Off-plane linear motion—1 axis (790)—Linear motion in the axis of the normal to the plane parallel to the element.
b. In-plane linear motion—2 axes (791)—Linear motion in the two main axes of a plane parallel to the element.
c. All linear motion—3 axes (792)—Linear motion in the two main axes of a plane parallel to the element, Linear motion in the axis of the normal to the plane parallel to the element Rotational motion around the axis of the normal to the plane parallel to the element
d. In-plane rotational motion—1 axis (793)
e. Off-plane rotational motion—2 axes (794): Rotational motion around the axis of the two main axes of a plane parallel to the element.
f. All rotational motion—3 axes (795): Rotational motion around the axis of the two main axes of a plane parallel to the element, Rotational motion around the axis of the normal to the plane parallel to the element.
g. All in-plane linear and rotational motion—3 axes (796): Linear motion in the two main axes of a plane parallel to the element, and rotational motion around the axis of the normal to the plane parallel to the element.
h. All rotational and in-plane linear motion—5 axes (797): Linear motion in the two main axes of a plane parallel to the element, rotational motion around the axis of the two main axes of a plane parallel to the element, rotational motion around the axis of the normal to the plane parallel to the element.
i. All linear and all rotational motion—6 axes (998). Linear motion in the two main axes of a plane parallel to the element, linear motion in the axis of the normal to the plane parallel to the element, rotational motion around the axis of the two main axes of a plane parallel to the element, and rotational motion around the axis of the normal to the plane parallel to the element.

At least one, some or all of the components of the optical unit of the LIDAR may be movable according to one or more motion types of FIG. 14.

Actuation mechanism—examples of manipulators and/or of components of the compensation unit. The actuation of optical elements in the event of degradations in optical unit alignment can be achieved in various ways. An element on the optical path is placed on an actuatable platform that can be actuated electrically by a control element. Different actuation mechanisms will differ by motion type, travel length, speed, resolution, accuracy, power consumption, dimensions, and cost. Some forms of actuation are outlined below:

MEMS actuation. Micro-Electro-Mechanical-System actuators are micron-scale systems that convert electrical signals into motion. There are numerous types of MEMS actuating mechanisms suited for a wide range of motion frequencies. MEMS based actuators are small, reliable, and often considered solid-state mechanisms, integrating well in automotive sensors.

Voice Coil Magnets (VCM). Voice Coil Magnets are a type of magnetic actuation that is achieved by attraction and repulsion forces between a static and a floating magnet, or between two floating magnets. At least one of the involved magnets can be externally controlled by increasing or decreasing the magnitude of its magnetic fields with electric currents. When designed carefully, this mechanism enables accurate motion. VCMs can be small in size, and they can be integrated in medium size optical systems such as commercial and smartphone cameras

Passive Temperature Expanded Platform (PTEP).

One of the causes of misalignment during runtime is temperature deformation of the substrate material. Use of another material with desired temperature expansion properties may revert the deformations without active intervention. Through careful design of the system materials and structure, two opposite responses to temperature shifts may cancel each other, significantly reducing the extent of misalignment caused by thermal deformations.

Active Temperature Expanded Platform (ATEP).

In a similar manner, Thermal expansion properties of materials can be used to actively compensate, mostly for low motion frequencies. By actively heating or cooling the involved substrates, a semi-static compensation of slowly generated deformations may be achieved. These deformations may or may not necessarily be a result of Thermal deformations.

Active control of material refractive index. The direction of the optical path can be controlled by temperature or by voltage induced over liquid crystals or other materials with refractive index sensitive to parameters (e.g. temperature, voltage, current).

### Actuated Elements.

Enabling controlled actuations of elements in the optical path enables accurate steering of the emitted illumination. In the event of environmentally caused deformation, steering can be used to compensate for misalignments. Any of the following may be used:

Actuated folding (flat) mirrors and prisms.

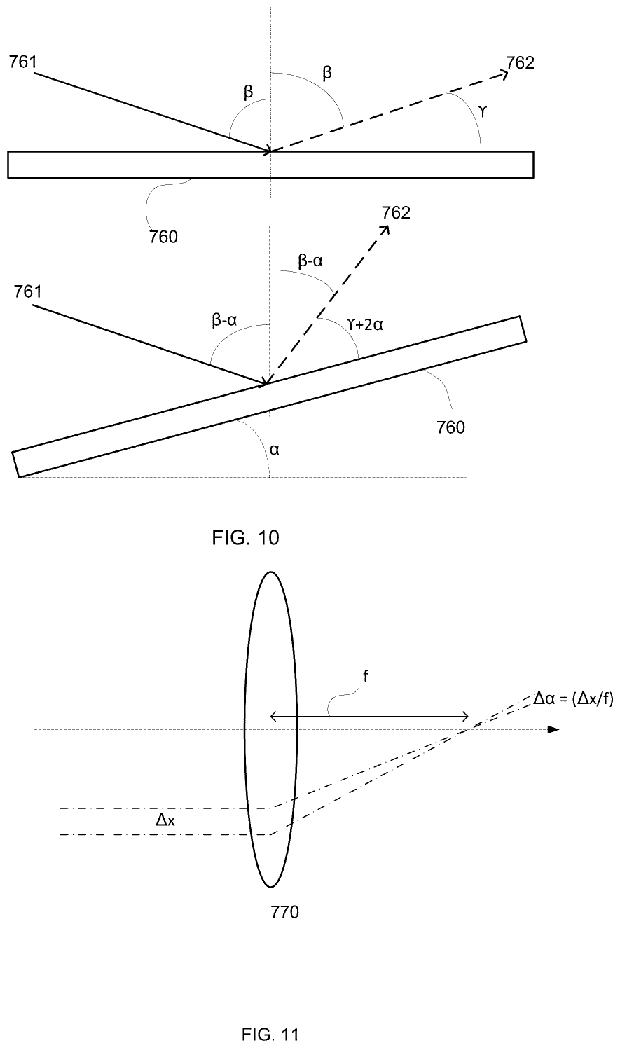

Rotational actuation applied to flat mirrors enables controlled angular steering of the laser beam. A tilt of the mirror 769 in an angle of α will steer the beam in an angle of 2α. (Shown in FIG. 10—the top part illustrates an aligned mirror and the lower part of FIG. 10 illustrates a tilted mirror). Impinging light beam denoted 768 and reflected light beam is denoted 769.

Actuated lenses, curved mirrors, collimators.

Translational linear actuation applied to lenses 770 and curved mirrors in the transverse plane enables controlled angular steering of the laser beam. For example, under paraxial approximation, a steer of 1° can be achieved by shifting the lens by a distance equal to 1.75% of the focal length. (Shown in FIG. 11).

Actuated laser source platform. When deformations occur in the transmitting channel and cause beam pointing error, a correction could be achieved by actuating the laser platform itself, either through angular shift or through a linear shift before a curved element.

Actuated photodetector platform. When deformations occur in the receiving channel (RX) and make the trace of the spot drift off the photodetector, a correction may be achieved by actuating the photodetector platform, through in-plane linear and angular actuations. Additionally, a beam defocus may be corrected by actuating the remaining linear and rotational axes. Further, the aiming accuracy may be enhanced by utilizing those degrees of freedom during the alignment process itself, saving time and tolerance demands in production line.

Feedback sensor. Dynamic Alignment should be triggered by some environmental condition or system state. By tracking those conditions, required compensation may be detected, and actuators may be actuated in either open or closed loop until the required compensation is achieved. A variety of sensors may be used, and each combination has its benefits.

Thermometers—temperature sensing. Temperature sensors are often inexpensive, convenient, and reliable sensors that enable tracking a temperature state. Since temperature has a direct impact on expansion and compression of materials, pointing errors are most often caused by temperature shifts. This relationship between temperature and expansion may be calibrated and inverted. A lookup-table may be generated, for example, for compensation size versus temperature shift. A thermometer is an efficient feedback sensor for the DA mechanism.

Accelerometers and gyroscopes—vibration sensing. Vibration sensors such as accelerometers and gyroscopes are useful for estimation of fast, dynamic errors of higher frequencies. Driving a car exposes the system to a wide band of vibrations, which can produce momentary blurring and plastic deformations.

An Optical Image Stabilizer (OIS) is a Dynamic Alignment mechanism which compensates for momentary blurring with faster actuations, in direct response to the vibrations. However, plastic deformations due to vibrations can be calibrated in advance, producing a lookup-table for size of compensation versus vibration profile over time. Thus, monitoring vibration profile may enable vibration cancellation. For these reasons, vibration sensors such as accelerometers and gyroscopes can operate as feedback sensor for the DA mechanism.

Strain gauge and other strain-meters—direct deformation sensing. Strain gauges are often inexpensive, convenient, and reliable sensors that enable direct measurement of a system's deformations. Temporal or permanent deformation can lead to pointing errors which can be calibrated in advance. A direct monitoring of these deformations can estimate the size of compensation required to invert their effect, and the strain gauge, for example, may be used as feedback sensor for the DA mechanism.

Photodetector power-meters—Indirect deformation sensing. Since the effect of deformations on beam steering is what we wish to solve, the state of the deformations themselves may be measured using an optical system. By using the same optical path, or by using a replica channel, the amount of deformation may be estimated. Photodetector power-meters may be used to either detect a deformation when it occurs, and serve as an iterative feedback sensor to detect when the deformation is resolved.

Signal tracking and analysis—Degradation sensing. In some scenarios, Dynamic Alignment can be applied with no additional sensors, relying solely on the built in sensors of the LIDAR system. Degraded performance may be detected by monitoring the system signal, where the alignment criteria is the optimization of the signal itself. An iterative feedback algorithm can connect between the identification of the alignment error and the corrected alignment point using closed loop form. Therefore, a tracking of the LIDAR system signal itself can operate as feedback sensor for the DA mechanism.

### Compensation Methodology.

Once a need for compensation is detected, the system initiates the compensating actuation process, targeting some stopping condition. This stopping condition can be in either open- or closed-loop, with the former being based on a Look-Up-Table (LUT, calibration) and the latter being based on an iterative algorithm. Any combination of the two can also be used to increase efficiency, accuracy, and reliability.

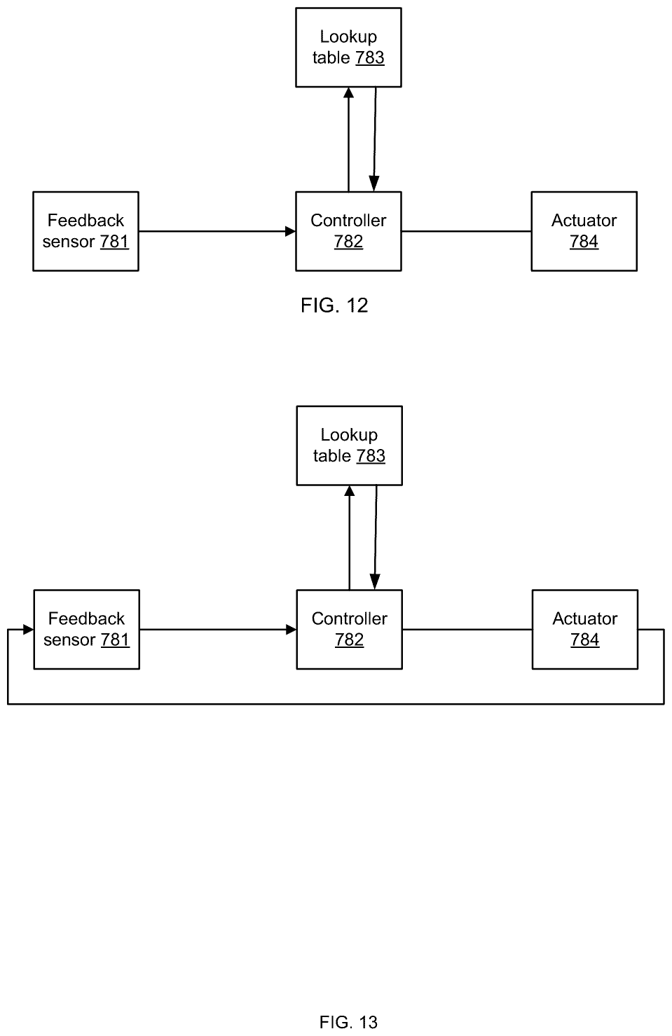

Look up table (LUT). A calibration-based compensation. A compensation Look-Up-Table (LUT) is a calibrated mapping of the required mechanical and/or thermal adjustment required in response to a sensed misalignment. This is mostly useful for slowly varying parameters that are independent of the actuation, such as temperature. For a given temperature, the amount of deformation can be calibrated in advance, and inversed during runtime. (Shown in FIG. 12).

It should be noted that the LUT may be replaced by other mapping processes. For example, a rule based decision may be applied, and/or a calculation of one or more formulas may be used, and/or by application of machine learning processes and/or by use one or more neural networks. Iterative compensation in closed loop. Iterative compensations includes algorithms of convergence with a stopping condition in smaller steps and a closed-loop feedback. The response of the feedback sensor after every iteration is analyzed to predict the next step, until the stopping condition is met. A feedback sensor can be used in combination with any of the sensors described in this application. This mechanism is more reliable since it allows sensing of the system's state during runtime, and it is suitable for faster varying parameters as well (Shown in FIG. 13).

Offline Vs. Online Compensation.

Different types of compensations and corrections may be initiated at different times during the lifetime of a system, depending on whether the correction response is due to static or dynamic degradations. We define three different types of compensation times: during production, during startup and during runtime.

Offline compensation—for example open loop compensation, the offline compensation may be performed in the production line. The first possible time of compensation is during the alignment and adjustment process in the production line. In some cases, the DA mechanism may enhance alignment capabilities, increase positioning resolution, or simply provide fine tuning of movements in one or more degrees of freedom. In such cases the DA mechanism is actuated during the alignment process itself and reinforce the process while reducing time and cost and improving performance.

This utilization of DA is suitable for deformations of very low frequencies such as a fixed offset from optimality.

Offline compensation—during system startup. The system may be compensated during startup of the system. The system startup usually takes place in a safe, stable position where there is plenty of time to boot. Deformations that did not exist in production and occurred later can be handled during startup. This utilization of DA is well suited for deformations of low to medium frequencies, such as temperature and aging deformations.

Online compensation—during system runtime. This may be closed loop compensation.

The system may be compensated is during. Due to a variety of parameters, the system performance may be degraded during operation. in order to retrieve optimal performance while avoiding a stop for a safe reboot, the system should support a sufficiently fast compensation mechanism.

This utilization of DA is well suited for deformations of medium and higher frequencies including cumulative temperature shifts during the ride, and stabilizing the video signal while suppressing shock and vibrations.

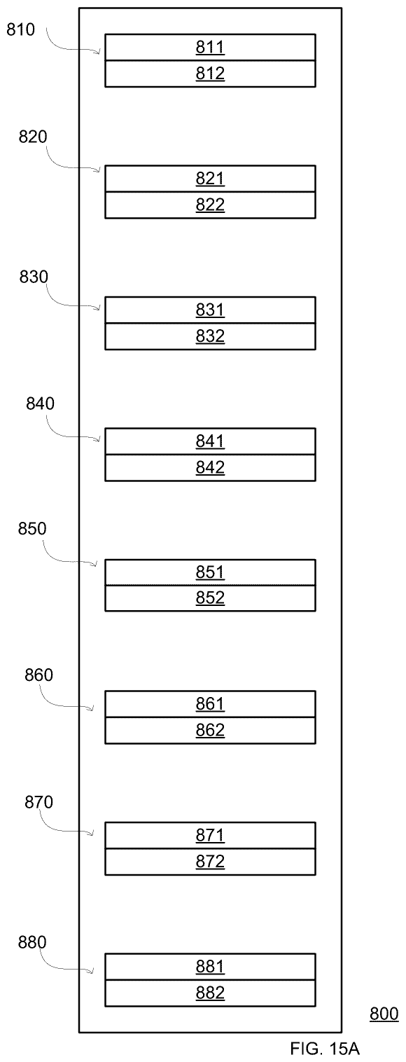

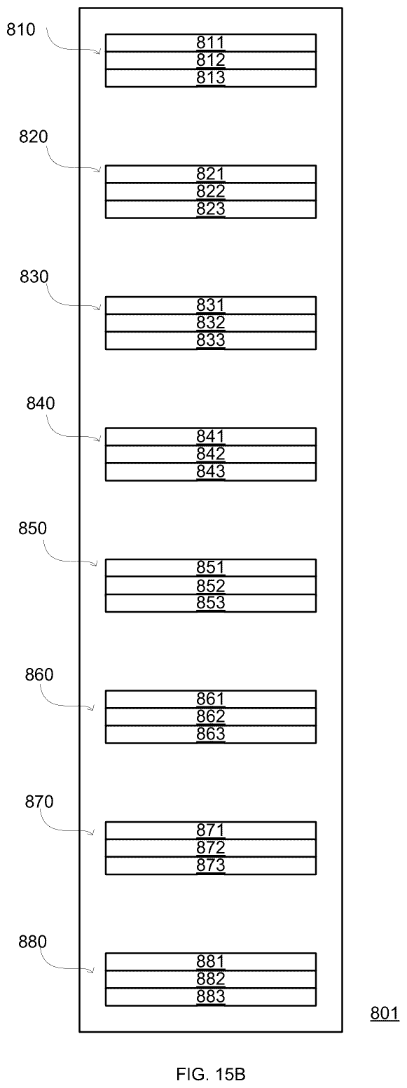

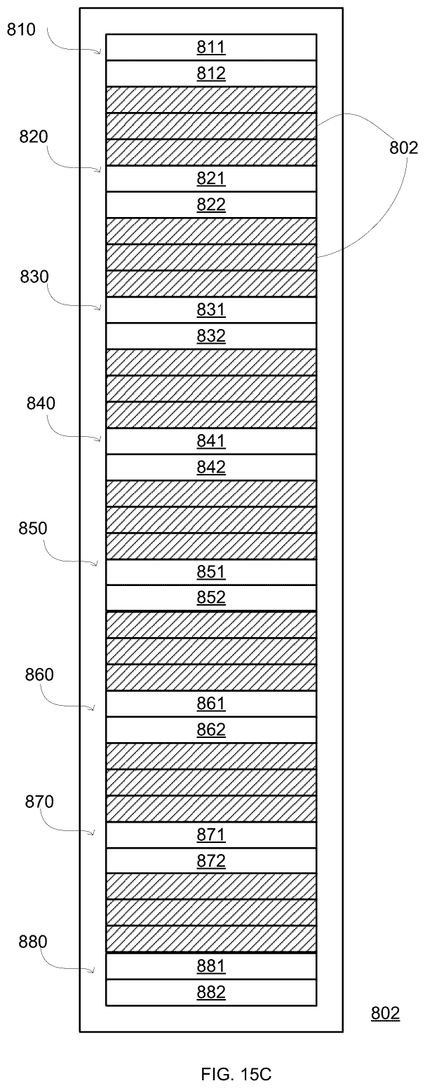

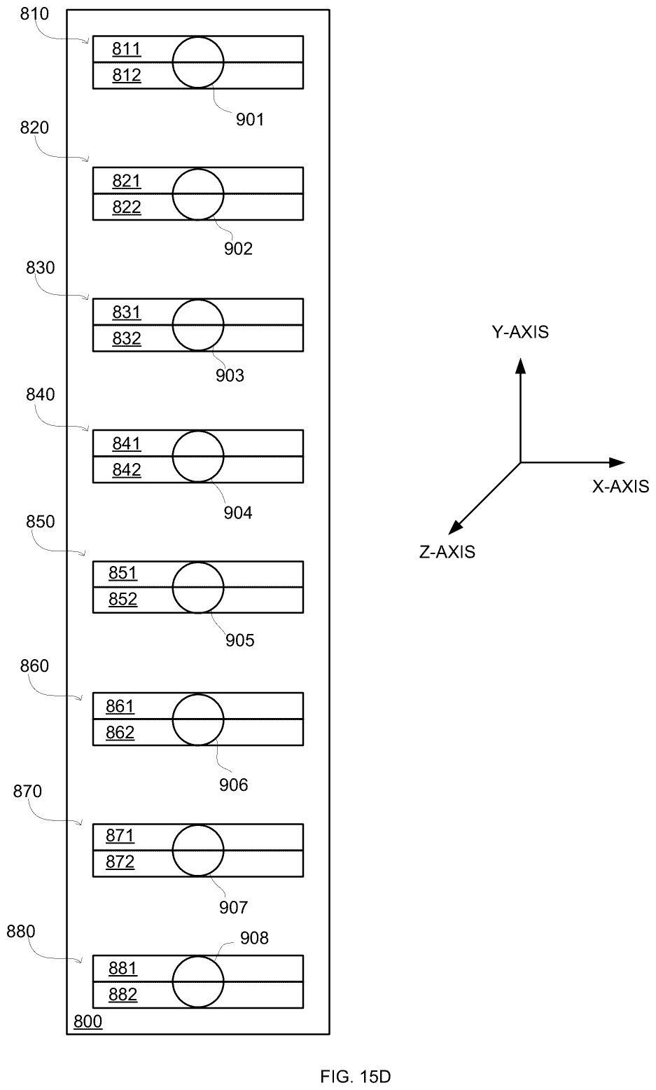

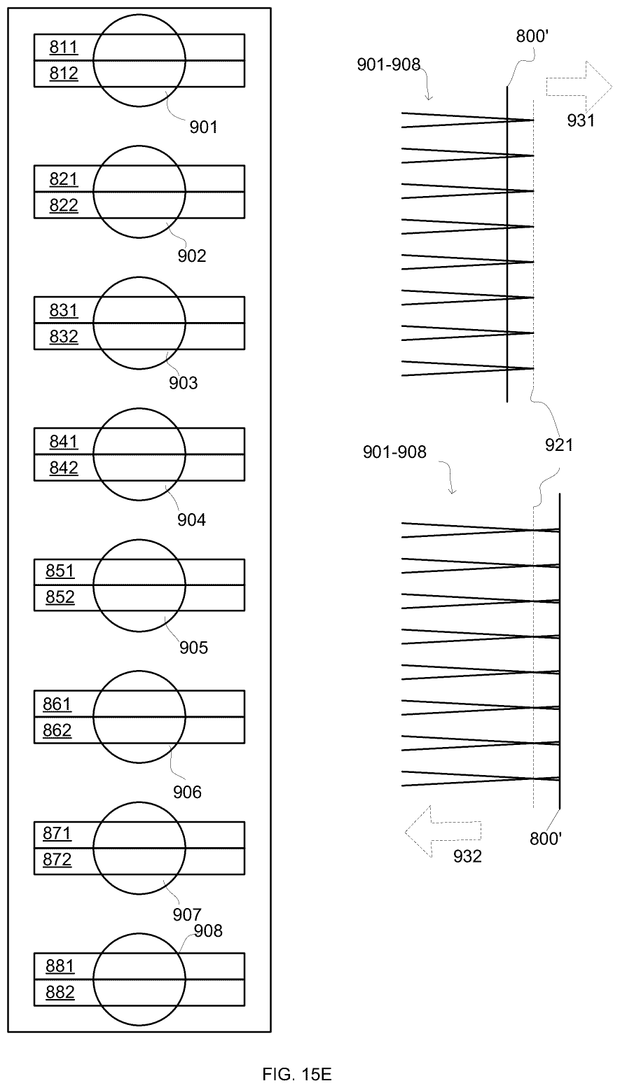

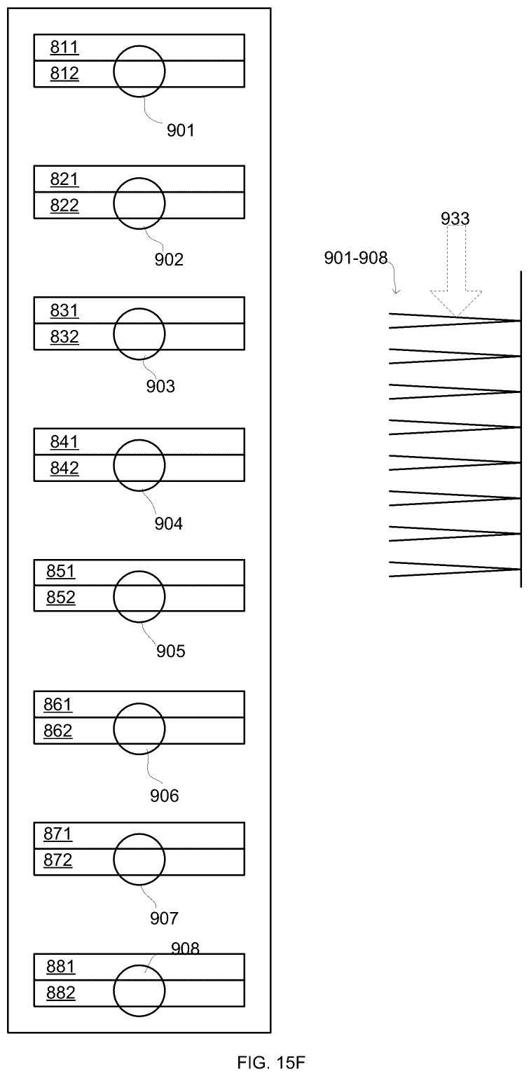

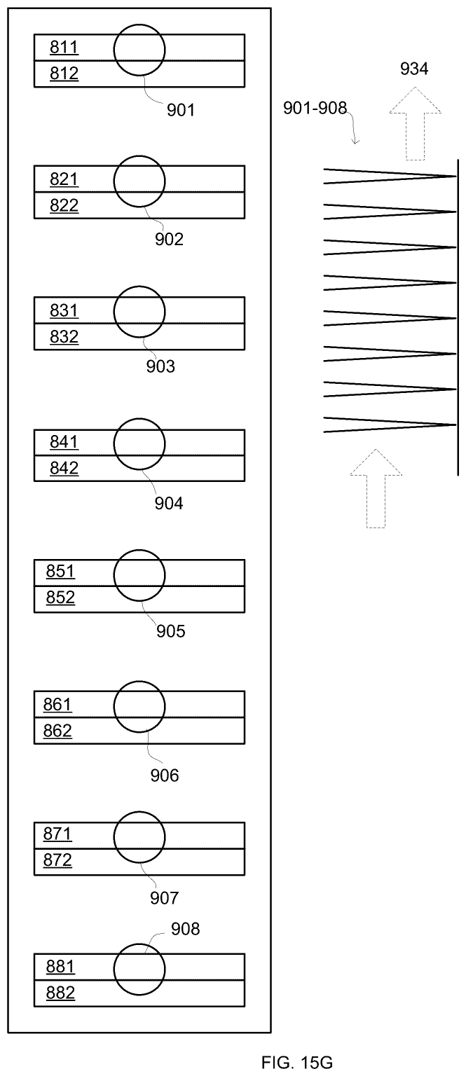

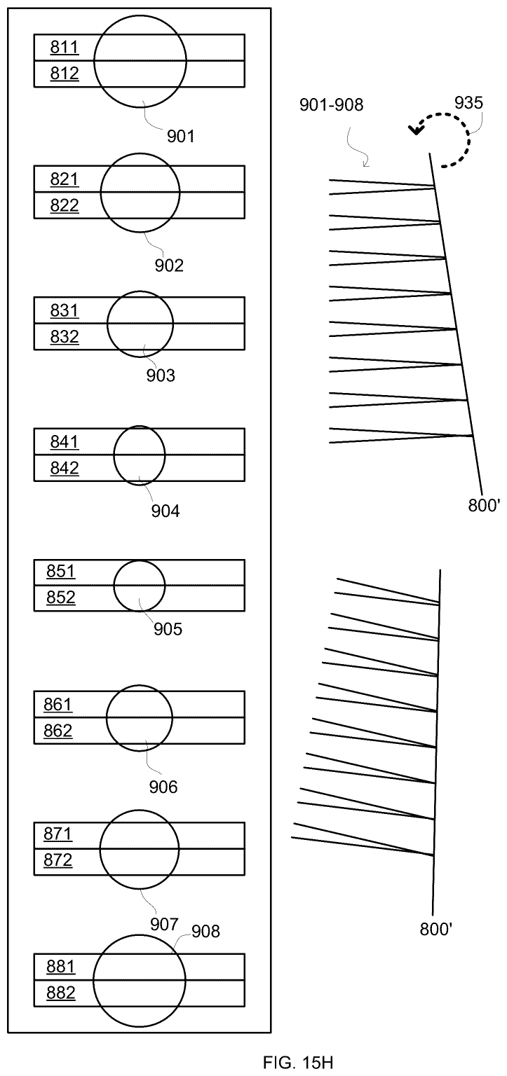

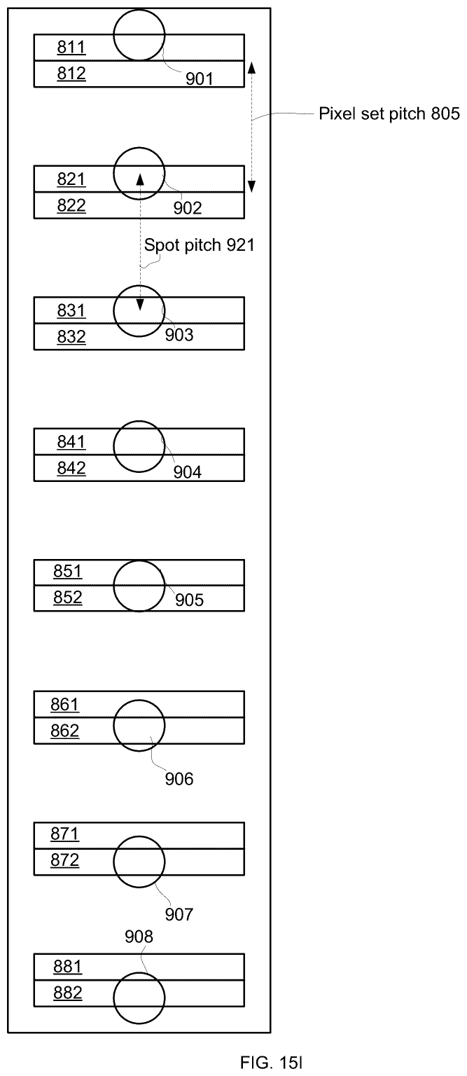

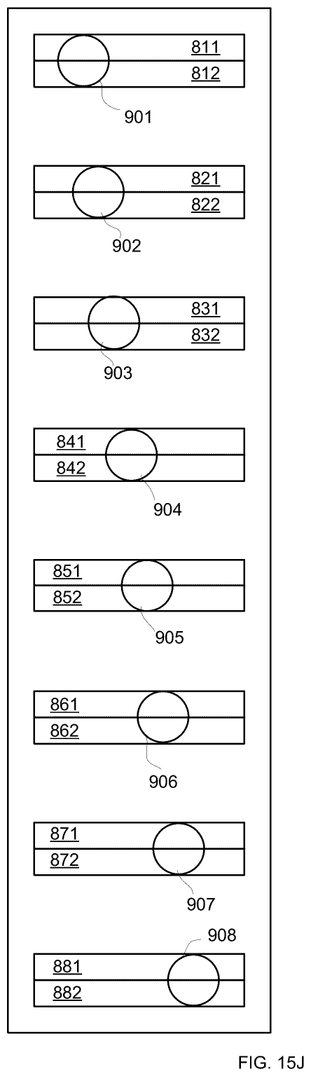

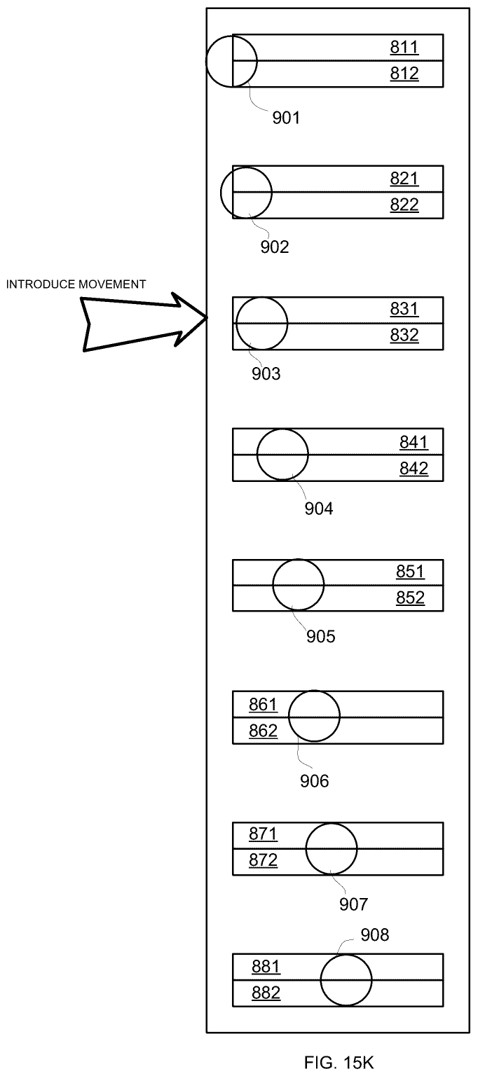

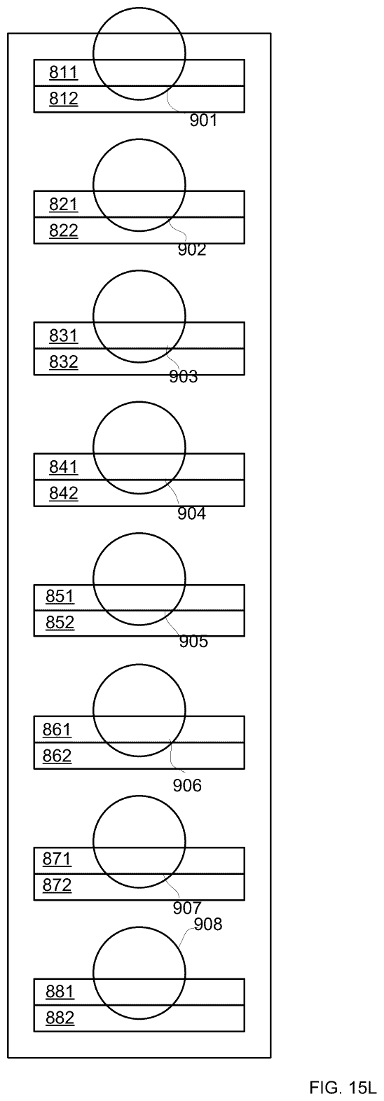

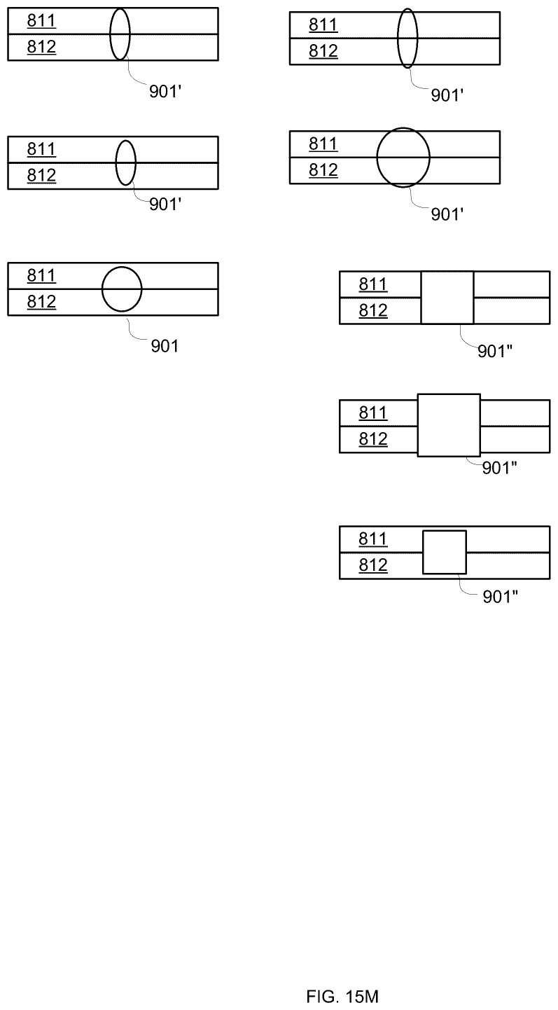

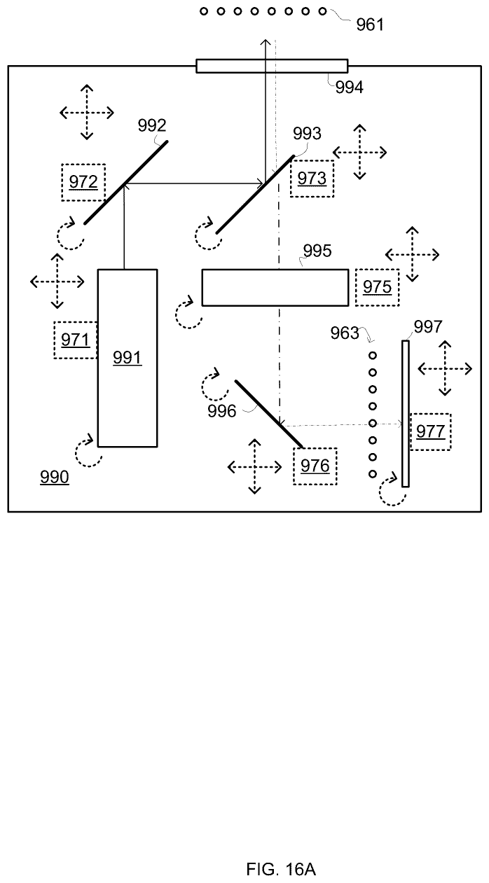

FIG. 15A illustrates an array 800 of sensing elements. The array includes eight sets of sensing elements 810, 820, 830, 840, 850, 860, 870 and 880. Each set includes two sensing elements (811, 812) of set 810, (821, 822) of set 820, (831, 832) of set 830, (841, 842) of set 840, (851, 852) of set 850, (861, 862) of set 860, (871, 872) of set 870, and (881, 882) of set 880. The sensing elements may be a part of a monolithic sensing array.

The number of sets may be smaller than eight, or may exceed eight. The number of sensing elements per set may be one, may be two or may exceed two. The number of sensing element in one or more sets may differ from the number of sensing elements in one more other sets. The sensing elements may be arranged in a 2D array, a 3D array, in an unordered manner, and the like.

FIG. 15B illustrates an array 801 of sensing elements. The array includes eight sets of sensing elements 810, 820, 830, 840, 850, 860, 870 and 880. Each set includes three sensing elements (811, 812, 813) of set 810, (821, 822, 823) of set 820, (831, 832, 833) of set 830, (841, 842, 843) of set 840, (851, 852, 853) of set 850, (861, 862, 863) of set 860, (871, 872, 873) of set 870, and (881, 882, 883) of set 880. The number of elements per set may exceed three.

FIG. 15C illustrates an array 802 of sensing elements in which the sets of sensing elements are spaced apart from each other by light inactive regions 802. It should be noted that the sensing elements between the sets may be activated.

FIG. 15D illustrates an example of an array 800 of sensing elements and an array of reflected light beams that form spots that are aligned (i.e. free of misalignments).

The entirety of first spot 901, second spot 902, third spot 903, fourth spot 904, fifth spot 905, sixth spot 906, seventh spot 907 and eighth spot 908 fall on the first set 810, the second set 820, the third set 830, the fourth set 840, the fifth set 805, the sixth set 806, the seventh set 807 and the eighth set 808, respectively.

In FIG. 15D, the center of each spot is located at the center of each corresponding set and the diameter of each spot equals the height of each set.

It should be noted that the diameter of a spot may differ from the height of each set—for example it may be smaller than the height of each set.

One or more spots may also deviate to the left or the right of the center of each set—and such deviations (at least to a certain degree) may be tolerable—and may still amount to a desirable pattern.

FIG. 15E illustrates an example of an array 800 of sensing elements and an array of reflected light beams that form spots that are misaligned, and exhibit a uniform defocus. A uniform defocus condition occurs when the focal points of the array of beams are located outside a plane 800′ of the sensing elements—and are within plane 921 that is parallel to the plane of the sensing elements 800′. The focal points may be preceded plane 800′ (see arrow 932) or may follow (see arrow 931) plane 800′.

When uniform defocus occurs—the reflected light beams (901-908) that impinge on the sets (810, 820, 830, 840, 850, 860, 870 and 880) of sensing elements to form spots that have a diameter that exceeds the height of the sets—and only a portion of each spot impinges on the set.

This will reduce the intensity of light that impinges on the pairs of sensing elements of FIG. 15E. When the centers of the reflected light spots are aligned with the center of the sets—the values of detection signals generated by sensing elements of each set form a symmetrical pattern. For example, the detection signals of sensing element 811 should be substantially equal to the detection signals of sensing element 812.

FIG. 15F illustrates an example of an array 800 of sensing elements and an array of reflected light beams that form spots that are misaligned—that are lower (see arrow 933) than expected.

FIG. 15G illustrates an example of an array 800 of sensing elements and an array of reflected light beams that form spots that are misaligned—that are higher (see arrow 934) than expected.

FIG. 15H illustrates an example of an array 800 of sensing elements and an array of reflected light beams that form spots that exhibit a focal points difference condition—the distance of a focal point of one reflected light beam and plane 800′ differs from the distance of a focal point of another reflected beam and plane 800′.

While FIG. 15H illustrates one focal point that falls on plane 800′—it should be noted that under a focal points difference condition there may zero or two spots that are in focus—their focal point are within plane 800′.

FIG. 15H illustrate two examples of the reasons that may result in focal points difference condition—a tilted (pitch angle) of plane 800′ (see arrow 935) and tilted reflected light beams. Another reason may be a curvature in the array of lights sources.

FIG. 15I illustrates an example of a pitch error—the distance between the centers of adjacent spots (spot pitch 921) differs from the distance between the centers of adjacent sets of sensing elements (pixel set pitch 805).

FIG. 15J illustrates an example of an array 800 of sensing elements and an array of reflected beams that form spots that provide an array of spots that are tilted (roll angle) in relation to the array.

FIG. 15K illustrates an example of an introduction of a controlled movement of one or more components of the optical unit—for example moving the array 800 of sensing elements to the right. The array 800 may be moved to the left. The controlled movement may be replaced by or made in addition to a deflection of the reflected light beams to the left or to the right.

The controlled movement assists in finding deviations of the spots along a traversal axis (for example along the x-axis)—for example for detecting roll angle rotations or just y-axis misalignment.

Any movement that can be performed by the compensation unit may be applied to detect one or more optical unit misalignments.

FIG. 15L illustrates an example of an array 800 of sensing elements and an array of reflected beams that form spots that provide an array of spots that are defocus and also are higher than expected (y-axis error). It should be noted that any combination of misalignments may be provided and may be compensated.

While the previous figures related to a circular spot that once focused has a diameter that equals the height of a set of sensing elements—these are merely non-limiting assumptions regarding the spot.

The spot may have any shape and/or may be of any size in relation to a set of sensing elements. FIG. 15M illustrates examples of spots 901′ and 901″ that have an elliptical shape or have polygon shaped—for example have a square shape, spots that have a dimension (for example height) that exceed one dimension (for example height)—of a set of sensing elements, and the like.

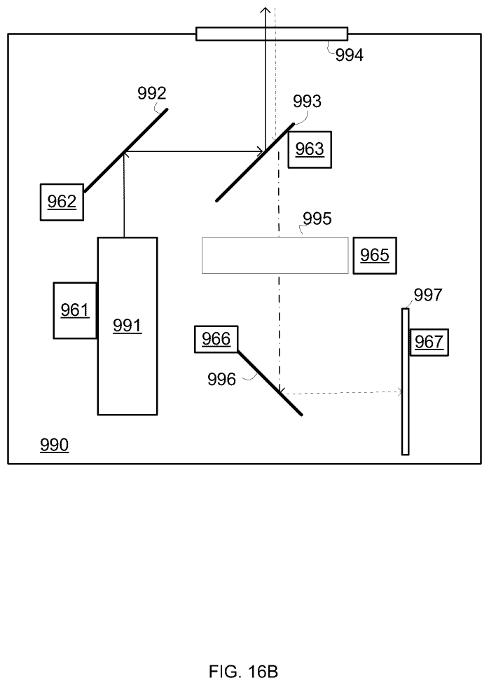

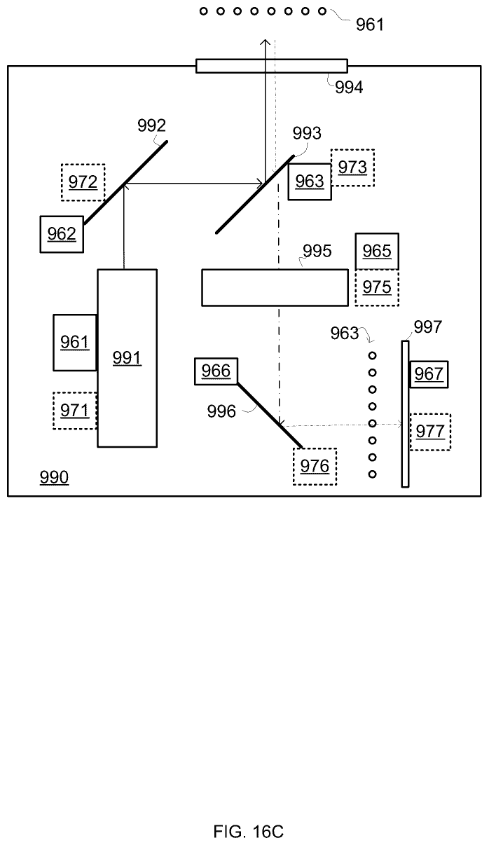

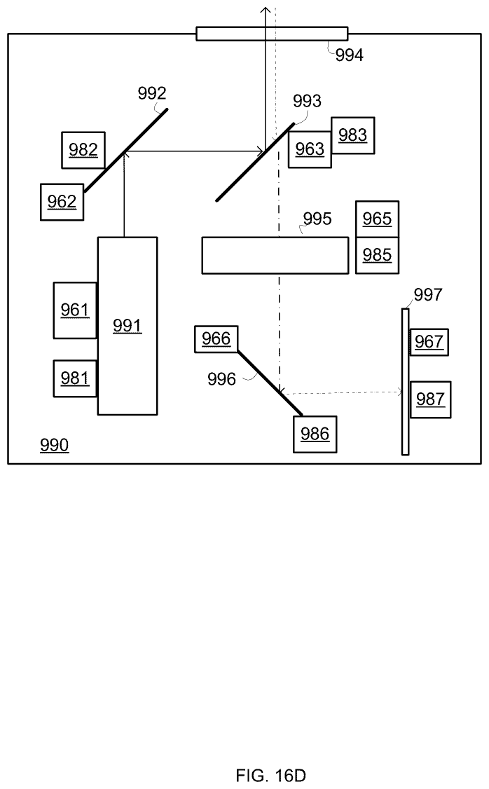

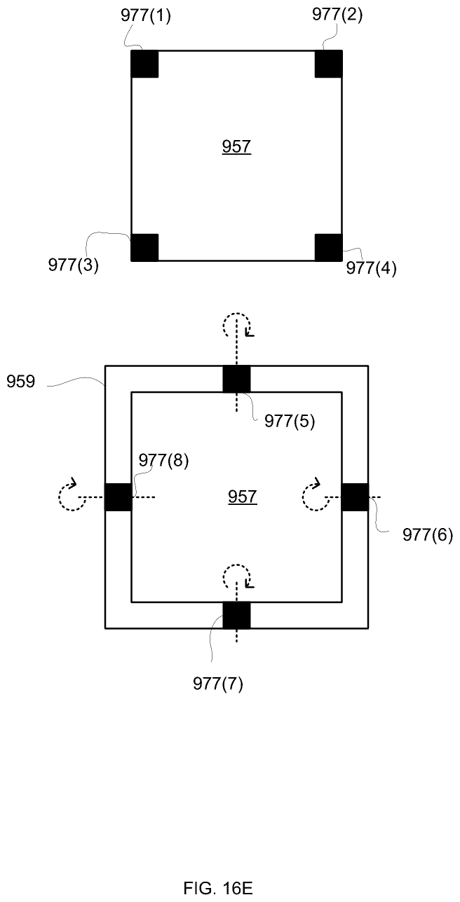

FIGS. 16A, 16B, 16C and 16D are examples of an optical unit 990 of a LIDAR system.

In each one of FIGS. 16A-16D the optical unit is illustrates as including a light source 991, first deflector 992, beam splitter 993, objective lens 995, second deflector 996 and a sensing unit 997. FIGS. 16A-16C also illustrates an array 961 of spots of light beams transmitted from the optical unit 990 and also illustrates an array of spots of reflected light beams that are directed towards the sensing unit 997.

It should be noted that the optical unit may include more than two deflectors, that the light source 991 may include one or more light sources such as a laser and one or more lenses, and that a deflector may be static and/or may rotate in order to deflect light beams towards a FOV to scan the FOV.

In FIG. 16A, the position and/or orientation of the light source 991 may be set by light source manipulator 971, the position and/or orientation of the first deflector 992 may be set by first deflector manipulator 972, the position and/or orientation of the beam splitter 993 may be set by beam splitter manipulator 973, the position and/or orientation of the objective lens 995 may be set by objective lens manipulator 975, the position and/or orientation of the second deflector 996 may be set by second deflector manipulator 976, and that the position and/or orientation of the sensing unit 997 may be set by sensing unit manipulator 977.

In FIG. 16B, the temperature of the light source 991 may be set by light source temperature control element 961, the temperature of the first deflector 992 may be set by first deflector temperature control element 962, the temperature of the beam splitter 993 may be set by beam splitter temperature control element 963, the temperature of the objective lens 995 may be set by objective lens temperature control element 965, the temperature of the second deflector 996 may be set by second deflector temperature control element 966, and the temperature of the sensing unit 997 may be set by sensing unit temperature control element 967.

FIG. 16C illustrates a combination of the manipulators 961-967 of FIG. 16A and the temperature control elements 961-967 of FIG. 16B. FIG. 16C also illustrates one or more temperature sensors 980 that may be configured to sense the temperature of one or more components of the optical unit.

FIG. 16D illustrates a combination of the temperature control elements 961-967 of FIG. 16B and temperature sensors 981-987 that are configured to sense the temperatures of light source 991, first deflector 992, beam splitter 993, objective lens 995, second deflector 996 and a sensing unit 997, respectively.

It should be noted that any combination of manipulators and temperature control elements can be provided. For example, only one or some of the optical components may have a manipulator and a temperature control element, an optical component may have only one of a manipulator and a temperature element, or an optical component may have no manipulator and no temperature control element.

FIG. 16E illustrates an example of various manipulators that may be fastened to one or more manipulated component in order to obtain different degrees of freedom. For example—sensing unit 997 may be mechanically coupled to another part of the optical unit using multiple manipulation elements that may perform any manipulation—for example tilt manipulation using manipulation elements 977(1)-977(4), or rotations about axes by manipulation elements 977(5)-977(8).

In some embodiments, the beam splitter may be configured to transmit each of the plurality of laser beams and to re-direct a plurality of reflected beams received from the field of view of the LIDAR system.

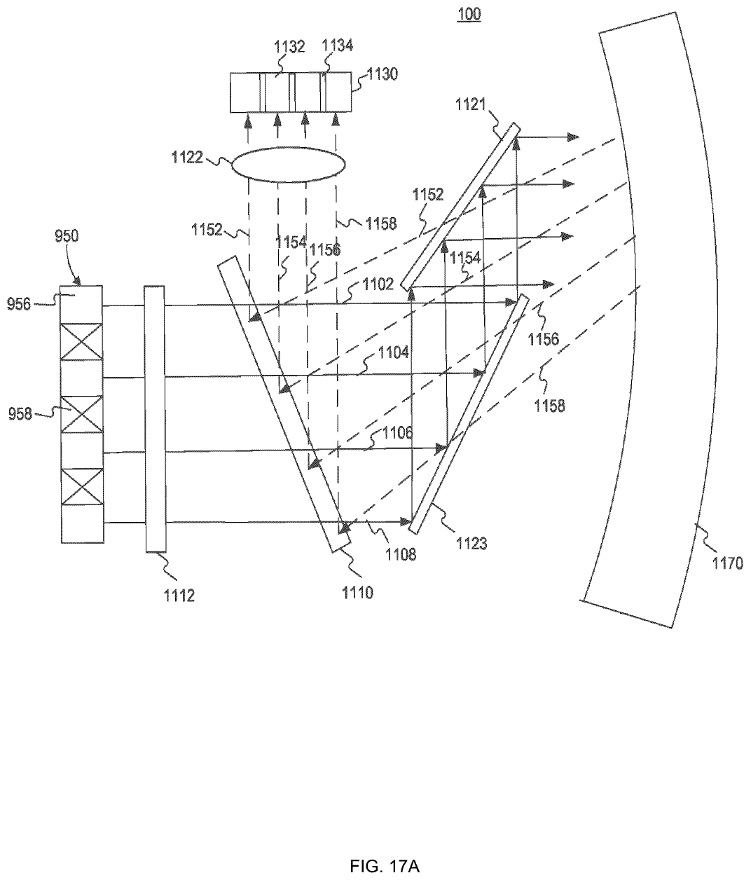

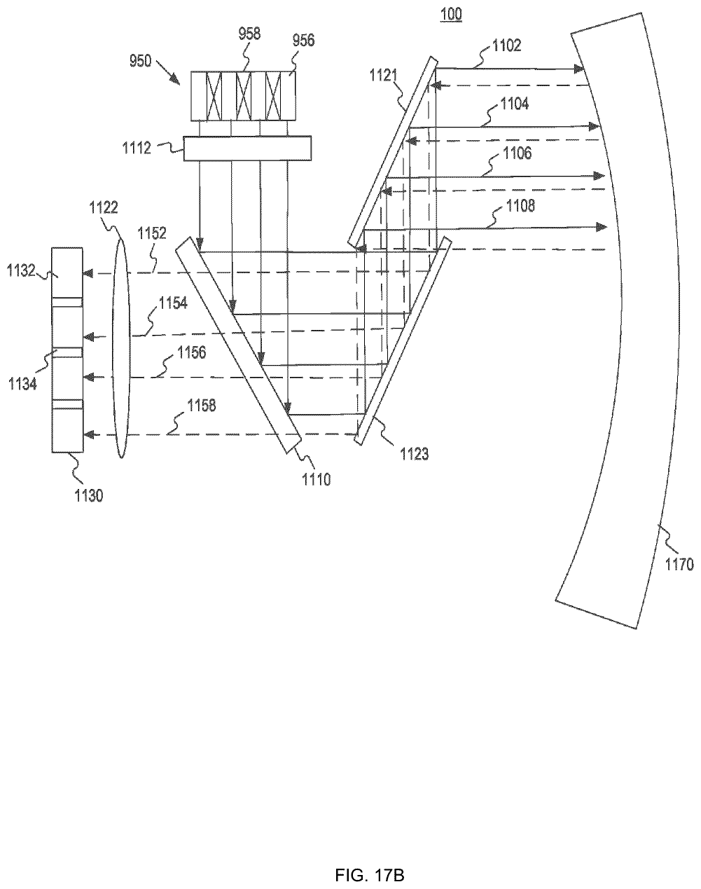

FIG. 17A illustrates an exemplary LIDAR system 100 including beam splitter 1110. As illustrated in FIG. 17A, LIDAR system 100 may include monolithic laser array 950 configured to emit one or more beams of laser light (e.g., 1102, 1104, 1106, 1108). The one or more beams of laser light may be collimated by one or more collimators 1112 before beams 1102, 1104, 1106, and/or 1108 are incident on beam splitter 1110. Beam splitter 1110 may allow laser light beams 1102, 1104, 1106, and/or 1108 to pass through and be incident on deflectors 1121, 1123, which may be configured to direct laser light beams 1102, 1104, 1106, and/or 1108 towards FOV 1170. Although only two deflectors 1121, 1123 have been illustrated in FIG. 17A, it is contemplated that LIDAR system 100 may include more than two deflectors 1121, 1123 configured to direct one or more of the light beams 1102, 1104, 1106, and/or 1108 towards FOV 1170.

One or more objects in FOV 170 may reflect one or more of the light beams 1102, 1104, 1106, and/or 1108. As illustrated in FIG. 17A, the reflected light beams may be represented as laser light beams 1152, 1154, 1156, and/or 1158. Although reflected laser light beams 1152, 1154, 1156, and/or 1158 are illustrated in FIG. 17A as being directly incident on beam splitter 1110, it is contemplated that some or all of light beams 1152, 1154, 1156, and/or 1158 may be directed by deflectors 1121, 1123 and/or another deflector towards beam splitter 1110. When light beams 1152, 1154, 1156, and/or 1158 reach splitter 1110, splitter 1110 may be configured to direct reflected light beams 1152, 1154, 1156, and/or 1158 received from FOV 1170 towards detector 1130 via lens 1122. Although FIG. 17A illustrates four light beams being emitted by monolithic laser array 950, it is contemplated that monolithic laser array 950 may emit any number of light beams (e.g., less than or more than four).

In some embodiments, the beam splitter is configured to re-direct each of the plurality of laser beams and pass a plurality of reflected beams received from the field of view of the LIDAR system. By way of example, FIG. 17B illustrates an exemplary LIDAR system 100 that may include monolithic laser array 950, collimator 1112, beam splitter 1110, deflector 1121, 1123, lens and/or optical filter 1122 and detector 1130. A monolithic laser array 950 may emit one or more laser light beams 1102, 1104, 1106, and/or 1108 that may be collimated by one or more collimators 1112 before being incident on beam splitter 1110.

Beam splitter 1110 may be configured to direct one or more of the laser light beams 1102, 1104, 1106, and/or 1108 towards deflectors 1121, 1123, which in turn may be configured to direct the one or more laser light beams 1102, 1104, 1106, and/or 1108 towards FOV 1170. One or more objects in FOV 1170 may reflect one or more of the laser light beams 1102, 1104, 1106, and/or 1108. Reflected laser light beams 1152, 1154, 1156, and/or 1158 may be directed by deflectors 1121, 1123 to be incident on beam splitter 1110. It is also contemplated that some or all of reflected laser light beams 1152, 1154, 1156, and/or 1158 may reach beam splitter 1110 without being directed by deflector 1121, 1123 towards beam splitter 1110.

As illustrated in FIG. 17B beam splitter 1110 may be configured to allow the reflected laser light beams 1152, 1154, 1156, and/or 1158 to pass through beam splitter 1110 towards detector 1130. One or more lenses and/or optical filters 1122 may receive the reflected laser light beams 1152, 1154, 1156, and/or 1158 and direct these light beams towards detector 1130. Although FIG. 17B illustrates four light beams being admitted by monolithic laser array 950, it is contemplated that monolithic laser array 950 may emit any number of light beams (e.g., less than or more than four).

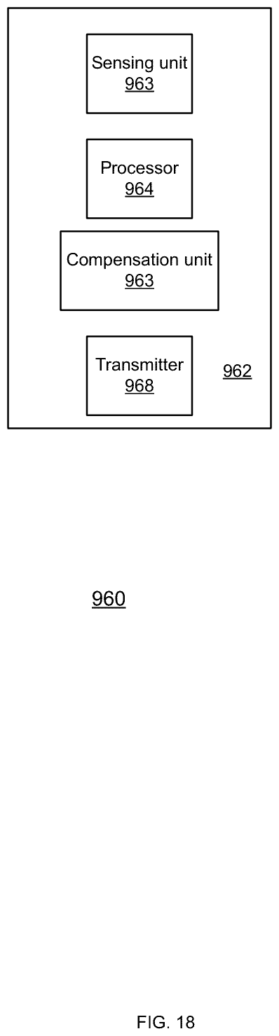

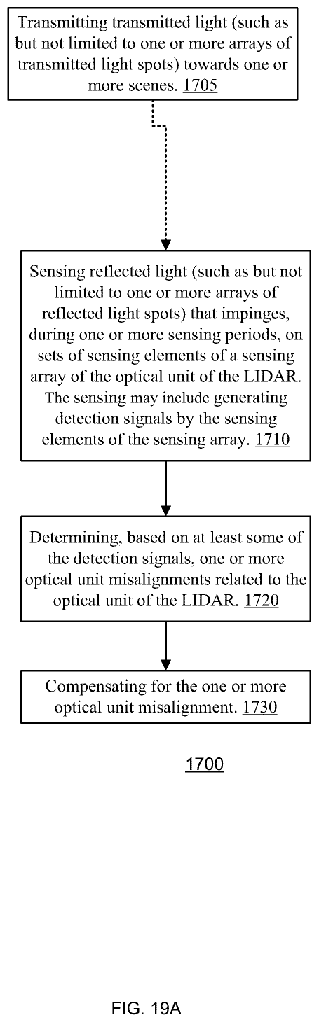

FIG. 18 is an example of a LIDAR 960 having dynamic alignment capabilities, the LIDAR 960 may include an optical unit 962 that may include a sensing unit 963, and a compensation unit 963.

The LIDAR 960 may include a processor 964. Processor 964 may belong to the optical unit or may not belong to the optical unit. The optical unit may include one or more components that may be misaligned. Examples of such components may include any component of a sensing unit, of a projecting unit or of a scanning unit.

The LIDAR may include a projecting unit 968 that may be configured to transmit one or more arrays of transmitted light spots towards one or more scenes. The one or more arrays of reflected spots are reflected from one or more objects within the one or more scenes. The projecting unit may include a projecting unit and the scanning unit. The scanning unit or at least one component of the scanning unit may be shared between the projecting unit and a receiver that includes the sensing unit. The LIDAR may also be configured to transmit light that differs from one or more transmitted light spots and/or is configured to receive reflected light that differs from an array of reflected light beams that form an array of spots on the sensing unit.

The processor 964 may be configured to control the compensation unit 966. Alternatively, the processor may not be configured to control the compensation unit.

The sensing unit 963 may include a sensing array that may include sets of sensing elements that are configured to sense one or more arrays of reflected light spots that impinge thereupon, during one or more sensing periods, on sensing regions of the sets of sensing elements of the sensing array.

The sensing unit may be configured to generate detection signals by the sensing elements of the sensing array.

The processor 964 may be configured to determine, based on at least some of the detection signals, one or more optical unit misalignments related to the optical unit of the LIDAR.

The processor may determine the one or more optical unit misalignments by generating generalized detection metadata that differs from scene specific metadata. While scene specific metadata may provide information about a specific scene—the generalized detection metadata is not limited to the details of a specific scene and may provide information about optical unit misalignments that may affect a “bias” or average of detection signals—as the optical unit misalignments may affect the detection signals regardless of a specific scene. The generalized detection metadata may be object-independent.

The generalized metadata is related to detection signals generated during one or more sensing periods.

An intensity of a reflected light beam that impinges on a sensing element may be dependent on the intensity of a transmitted light beam, on the distance between the LIDAR and the object that reflects the light beam, on the reflectivity of the region of the object that reflected the transmitted light beam and on the one or more misalignments of the optical unit. The distance to the object is known based on the time of flight. The intensity of the projected light beam is known. If enough detected signals are obtained and processed (for example averaged) then the reflectivity of the regions that reflected transmitted light beams can be disregarded. Thus—when obtaining enough detected signals then the one or more misalignments of the optical unit may be calculated.

What amounts to ‘enough detected signals’ may be determined to provide a tradeoff between accuracy and required resources to determine the one or more misalignments of the optical unit, and/or the time required to determine the one or more misalignments of the optical unit. Non-limiting examples of enough detected signals may be detected signals acquired during tens of frames (for example forty) a few hundred, one thousand, ten thousand, one hundred thousand, million or more detection signals.

It should be noted that some misalignments of the optical unit that can be detected based on differences between detection signals sensed by sensing elements of the same set of sensing elements, may require less detection signals than other misalignments of the optical unit that may be determined based, at least in part, to the detection signals detected by an entire set. The former may include vertical shift of the array of spots, and the latter may include uniform defocus condition.

A sensing period may last one or more seconds, one or more minutes, one or more hours, one or more days, and the like.

The compensation unit 966 may be configured to compensate for the one or more optical unit misalignment. Compensating may include partially compensating or fully compensating. The compensation unit may differ from the processor, or may be implemented, at least in part, by the processor.

The one or more optical misalignment may include a misalignment of the sensing array.

The sensing elements may be light sensitive regions. The different sets of sensing elements may be spaced apart by one or more light inactive regions. The sensing elements may be a part of a monolithic array of light sensitive active regions. A sensing element of a set of sensing elements may be configured to sense only a portion of a reflected light spot. A set of sensing elements may be configured to sense (assuming the system is aligned) only a single spot, only a predefined portion (for example 70, 80, 90% or any other predefined portion) of a single spot, or may be configured to sense more than a single spot.

The processor may be configured to perform during the determining, at least one of:
a. Searching for at least one local misalignment, wherein a local misalignment may be related to a set of sensing elements.
b. Determining based on two or more local misalignments.
c. Comparing between the two or more local misalignments.
d. Finding a uniform defocus condition based on the two or more local misalignments.
e. Finding a uniform defocus condition may include determining that (a) each set of sensing elements sensed less than a predefined portion of a single reflected light spot, (b) different sets of sensing elements sensed a same portion of a reflected light spot, and (c) for each set of sensing elements, values of detection signals of different sensing of the set of sensing elements form a symmetrical pattern. This finding may occur when each set of sensing elements is configured to sense a single reflected light spot.
f. Finding a focal points difference condition based on the two or more local misalignments.
g. Sensing a single reflected light spot. In this case the finding of the differential focus condition may include finding that (a) each set of sensing elements sensed less than a predefined portion of a single reflected light spot, (b) at least two sets of sensing elements sensed different portions of a reflected light spot, and (c) for each set of sensing elements, values of detection signals of different sensing of the set of sensing elements form a symmetrical pattern. This finding may occur when each set of sensing elements is configured to sense a single reflected light spot.
h. Finding a displacement condition based on the two or more local misalignments.
i. Finding a pitch error based on the two or more local misalignments. The finding of a pitch misalignment may be executed while centers of adjacent sets of sensing elements may be spaced apart by an inter-set distance that equals a pitch of an array of reflected light spots obtained at an absence of misalignment.
j. Comparing between detection signals generated by at least two different sensing elements of a set of sensing elements.
k. Setting a temperature of at least one component of the optical unit during the one or more sensing periods.
l. Setting a location and/or orientation of at least one component of the optical unit during the one or more sensing periods.
m. Generating generalized detection metadata that differs from scene specific metadata.
n. Participate in the compensation. For example controlling the compensation, sending commands that once applied will result in compensating.
o. Apply one or more signal processing operations for compensation. For example—enhance detection signals, increasing SNR of detection signals, or amplifying the detection signals.

The compensation unit may be configured to perform at least one of:
a. Reducing differences between the detection signals generated by the at least two different sensing elements of the set.
b. Setting a temperature of at least one element of the optical unit. The at least one element may include the array of sensing elements or may not include the array of sensing elements.
c. Changing a position and/or orientation of at least one optical element of the optical unit. The at least one element may include the array of sensing elements or may not include the array of sensing elements.
d. Apply one or more signal processing operations for compensation.

The LIDAR may be configured to introduce controlled movement of one or more components of the optical unit. The controlled movement may be executed by the compensation unit or by a mechanical unit that may be used for both compensation and measurements or only for measurements.

The LIDAR that may be configured to control a temperature of at least one component of the optical unit.

The one or more optical unit misalignment may include a temperature related optical unit misalignment.

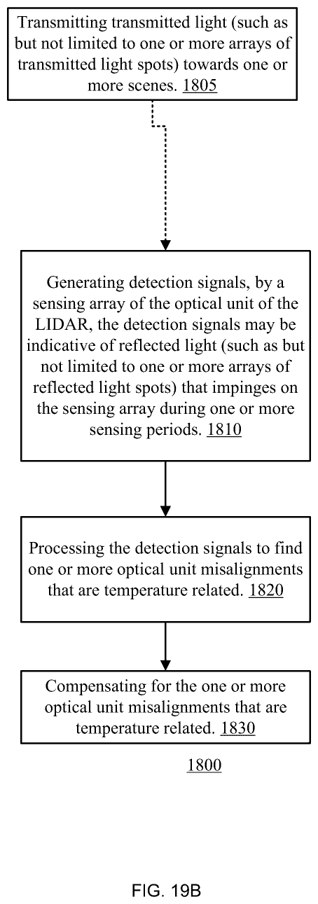

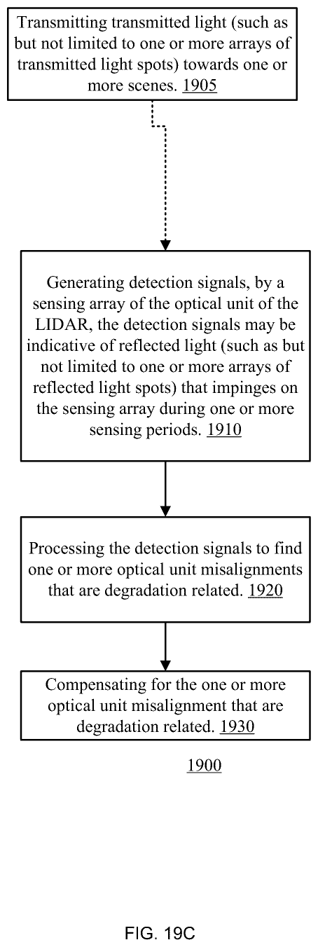

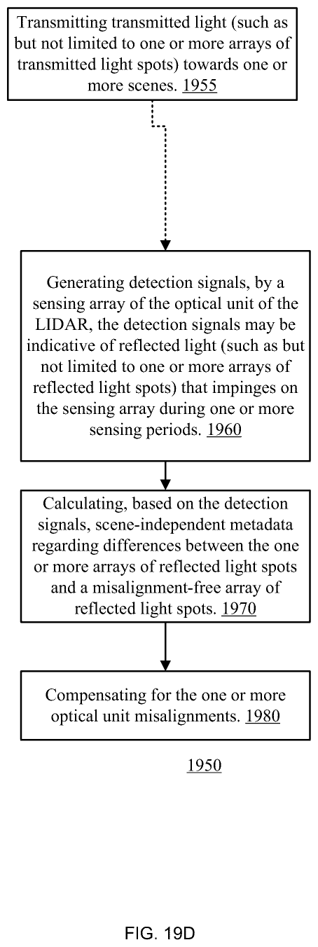

FIG. 19A illustrates an example of method 1700 for dynamic alignment of an optical unit of a LIDAR.

Method 1700 may start by step 1710 of sensing reflected light (such as but not limited to one or more arrays of reflected light spots) that impinges, during one or more sensing periods, on sets of sensing elements of a sensing array of the optical unit of the LIDAR. The sensing may include generating detection signals by the sensing elements of the sensing array.

Step 1710 may be followed by step 1720 of determining, based on at least some of the detection signals, one or more optical unit misalignments related to the optical unit of the LIDAR.

The determining may include generating generalized detection metadata that differs from scene specific metadata. While scene specific metadata may provide information about a specific scene—the generalized detection metadata is not limited to the details of a specific scene and may provide information about optical unit misalignments that may affect a “bias” or average of detection signals—as the optical units misalignments may affect the detection signals regardless of a specific scene. The generalized detection metadata may be object-independent.

The generalized metadata is related to detection signals generated during one or more sensing periods.

An intensity of a reflected light beam that impinges on a sensing element may be dependent on the intensity of a transmitted light beam, on the distance between the LIDAR and the object that reflects the light beam, on the reflectivity of the region of the object that reflected the transmitted light beam and on the one or more misalignments of the optical unit. The distance to the object is known based on the time of flight. The intensity of the transmitted light beam is known. If enough detected signals are obtained and processed (for example averaged) then the reflectivity of the regions that reflected transmitted light beams can be ignored of. Thus—when obtaining enough detected signals then the one or more misalignments of the optical unit may be calculated.

What amounts to enough detected signals may be determined to provide a tradeoff between accuracy and required resources to determine the one or more misalignments of the optical unit, and/or the time required to determine the one or more misalignments of the optical unit.

Non-limiting examples of enough detected signals may be a few hundreds, one thousand, ten thousand, one hundred thousand, million or more detection signals.

It should be noted that some misalignments of the optical unit that can be detected based on differences between detection signals sensed by sensing elements of the same set of sensing elements, may require less detection signals than other misalignments of the optical unit that may be determined based, at least in part, to the detection signals detected by an entire set. The former may include vertical shift of the array of spots, and the latter may include uniform defocus condition.

A sensing period may last less than a second, one or more seconds, 1-3 seconds, 2 seconds, one or more minutes, one or more hours, one or more days, and the like.

Step 1720 may be followed by step 1730 of compensating for the one or more optical unit misalignment. Compensating may include partially compensating or fully compensating.

The one or more optical misalignment may include a misalignment of the sensing array.

The sensing elements may be light sensitive regions. The different sets of sensing elements may be spaced apart by one or more light inactive regions. The sensing elements may be a part of a monolithic array of light sensitive active regions. A sensing element of a set of sensing elements may be configured to sense only a portion of a reflected light spot.

Step 1710 may be preceded by step 1705 of transmitting transmitted light such as but not limited to one or more arrays of transmitted light spots towards one or more scenes. The one or more arrays of reflected spots may be reflected from one or more objects within the one or more scenes.

Step 1720 of determining may include at least one of:
a. Searching for at least one local misalignment, wherein a local misalignment may be related to a set of sensing elements. A local misalignment is a misalignment that can be related to one or more sensing element other than an entirety of the sensing elements of the sensing units. A local misalignment may be related to only one or more of spots that impinge on the sensing unit.
b. Determining based on two or more local misalignments.
c. Comparing between the two or more local misalignments.
d. Finding a uniform defocus condition based on the two or more local misalignments.
e. Finding a uniform defocus condition may include determining that (a) each set of sensing elements sensed less than a predefined portion of a single reflected light spot, (b) different sets of sensing elements sensed a same portion of a reflected light spot, and (c) for each set of sensing elements, values of detection signals of different sensing of the set of sensing elements form a symmetrical pattern. This finding may occur when each set of sensing elements is configured to sense a single reflected light spot.
f. Finding a focal points difference condition based on the two or more local misalignments.
g. Sensing a single reflected light spot; and wherein the finding of the differential focus condition may include finding that (a) each set of sensing elements sensed less than a predefined portion of a single reflected light spot, (b) at least two sets of sensing elements sensed different portions of a reflected light spot, and (c) for each set of sensing elements, values of detection signals of different sensing of the set of sensing elements form a symmetrical pattern. This finding may occur when each set of sensing elements is configured to sense a single reflected light spot.
h. Finding a displacement condition based on the two or more local misalignments.
i. Finding a pitch error based on the two or more local misalignments. The finding of a pitch misalignment may be executed while centers of adjacent sets of sensing elements may be spaced apart by an inter-set distance that equals a pitch of an array of reflected light spots obtained at an absence of misalignment.
j. Comparing between detection signals generated by at least two different sensing elements of a set of sensing elements.
k. Setting a temperature of at least one component of the optical unit during the one or more sensing periods.
l. Setting a location and/or orientation of at least one component of the optical unit during the one or more sensing periods.
m. Generating generalized detection metadata that differs from scene specific metadata.

Step 1730 may include at least one of:
a. Reducing differences between the detection signals generated by the at least two different sensing elements of the set.
b. Setting a temperature of at least one element of the optical unit. The at least one element may include the array of sensing elements or may not include the array of sensing elements.
c. Changing a position and/or orientation of at least one optical element of the optical unit. The at least one element may include the array of sensing elements or may not include the array of sensing elements.

One or more examples of generalized detection metadata values and the finding of misalignment are illustrated below.

Assuming that without misalignment each sensing elements of each of the eight sets of FIGS. 15E-15H, should sense reflected light having an intensity Ise.

A uniform defocus (see FIG. 15E) may be detected when the generalized detection metadata indicates that each sensing element of each set of the eight sets senses an intensity of Q*Ise, whereas Q is smaller than one. The value of Q is indicative of the amount of defocus—as smaller values of Q are indicative of increased defocus.

Spots that are positioned lower than expected (see FIG. 15F) can be detected when upper sensing elements of each set sense an intensity Rup*Ise, the lower sensing elements of each set sense an intensity of Ise, whereas Rup is smaller than one. The value of Rup is indicative of the misalignment.

Spots that are higher than expected (see FIG. 15G) can be detected when upper sensing elements of each set sense an intensity Ise, the lower sensing elements of each set sense an intensity of Rdown*Ise, whereas Rdown is smaller than one. The value of Rdown is indicative of the misalignment.

FIG. 19B illustrates an example of method 1800 for temperature based dynamic alignment of an optical unit of a LIDAR.

Method 1800 may start by step 1810 of generating detection signals, by a sensing array of the optical unit of the LIDAR, the detection signals may be indicative of reflected light (such as but not limited to one or more arrays of reflected light spots) that impinges on the sensing array during one or more sensing periods.

Step 1810 may be followed by step 1820 of processing the detection signals to find one or more optical unit misalignments that are temperature related.

The one or more optical unit misalignments that are temperature related may cause differences between the one or more arrays of reflected light spots and a misalignment-free array of reflected light spots.

Step 1820 may be followed by step 1830 of compensating for the one or more optical unit misalignment.

Step 1820 may include generating generalized detection metadata regarding the detection signals; and wherein the finding may be based on the scene independent metadata.

The generating of the scene-dependent metadata may include averaging detection signals obtained during a sensing period of at least one second.

Step 1810 may be preceded by step 1805 of transmitting transmitted light such as but not limited to one or more arrays of transmitted light spots towards one or more scenes. The one or more arrays of reflected spots may be reflected from one or more objects within the one or more scenes.

FIG. 19C illustrates an example of method 1900 for degradation based dynamic alignment of an optical unit of a LIDAR.

Method 1900 may start by step 1910 of generating detection signals, by a sensing array of the optical unit of the LIDAR, the detection signals may be indicative of reflected light (such as but not limited to one or more arrays of reflected light spots) that impinges on the sensing array during one or more sensing periods.

Step 1910 may be followed by step 1920 of processing the detection signals to find one or more degradation based optical unit misalignments.

Step 1920 may be followed by step 1930 of compensating for the one or more degradation based optical unit misalignments.

Step 1920 may include generating generalized detection metadata that differs from scene specific metadata. The finding may be based on the generalized detection metadata.

The generating of the generalized detection metadata may include averaging detection signals obtained during a sensing period of at least 1, 2, 4, 6, 8, 10, 12 seconds.

Step 1910 may be preceded by step 1905 of transmitting transmitted light such as but not limited to one or more arrays of transmitted light spots towards one or more scenes. The one or more arrays of reflected spots may be reflected from one or more objects within the one or more scenes.

Degradation based optical unit misalignment may differ from temperature based optical unit misalignment by duration and/or trend. For example—temperature based optical unit misalignments may last while the temperature fulfills a certain condition—and may last for one or more minutes, one or more hours and the like. Degradation based optical unit misalignments may last for months and years. Yet for another example—degradation based optical unit misalignments tend to worsen over time while temperature based optical unit misalignments are reversible.

FIG. 19D illustrates an example of method 1950 for degradation based dynamic alignment of an optical unit of a LIDAR.

Method 1950 may start by step 1960 of generating detection signals, by a sensing array of the optical unit of the LIDAR, the detection signals are indicative of reflected light (such as but not limited to one or more arrays of reflected light spots) that impinges on the sensing array during one or more sensing periods.

Step 1960 may be followed by step 1970 of calculating, based on the detection signals, scene-independent metadata regarding differences between the one or more arrays of reflected light spots and a misalignment-free array of reflected light spots.

Scene-independent metadata does not provide explicit information about objects that reflected light towards the sensing array but rather provides information about optical unit misalignments that may affect a “bias” or average of detection signals—as the optical units misalignments may affect the detection signals regardless of a specific scene.

Step 1970 may be followed by step 1980 of compensating for the one or more optical unit misalignment, wherein the compensating is based on the scene-independent metadata.

Step 1970 may include averaging at least a predefined number of detection signals.

Step 1960 may be preceded by step 1955 of transmitting transmitted light such as but not limited to one or more arrays of transmitted light spots) towards one or more scenes. The one or more arrays of reflected spots may be reflected from one or more objects within the one or more scenes.

### Dedicated Feedback Sensing Elements

It has been found that there may be sensing elements that may be used for different purposes—for example there may be sensing elements that are used to perform distance measurements (time of flight based distance measurements)—and there may be sensing elements that may be dedicated for other purposes—for example—for providing feedback—such as misalignment feedback. For simplicity of explanation, sensing elements used for distance measurements are referred to as distance measurement (DM) sensing elements and sensing elements used for feedback are referred to as feedback sensing elements.

The roles of feedback sensing elements are fixed—are statically allocated, such that a DM sensing element is not used for providing feedback—and feedback sensing elements are not used for distance measurements. The roles of DM sensing elements may be fixed—although they may be used, along with the feedback sensing elements—for feedback measurements.

A DM sensing element and a feedback sensing element may be of the same shape and size or may differ from each other by shape and/or size.

There may be any relationship between a number of DM sensing elements of an array of sensing elements and a number of feedback sensing elements of the array of sensing elements. In many cases the number of DM sensing elements may exceed the number of feedback sensing elements.

The feedback sensing element may provide misalignment information related to one or more directions—for example may provide vertical misalignment information and/or horizontal misalignment information and/or misalignment along any direction information. The misalignment may be determined based on signals received from the feedback sensing elements.

For example, signals above a threshold level, signals greater than zero (for a position where a reflection is unexpected), or a difference between signals (e.g. a difference between vertically offset feedback elements, or a difference between horizontally offset feedback elements, or both), which may indicate a specific misalignment.

Each feedback sensing element outputs a feedback signal. Each feedback signal may be conveyed over a dedicated output path of the array. Alternatively, a difference between two or more feedback signals is locally calculated (within the sensor unit) and conveyed over a dedicated difference signal output path. This reduces the number of paths from the array. Based on the a detected misalignment from feedback signals, an alignment correction may be applied as outlined in various embodiments in this specification.

There is provided a distance measurement (DM) optical sensor, that includes:
a. A two-dimensional sensing array that includes sensing elements. The sensing elements include DM sensing elements and feedback sensing elements. The feedback sensing elements are statically allocated to act as feedback sensing elements.
b. Output paths that include DM output paths and feedback output paths.

The feedback sensing elements may be arranged in a group of feedback sensing elements.

The DM sensing elements may be arranged in a group of DM sensing elements.

The group of feedback sensing elements is associated with the group of DM sensing elements in the sense that the feedback sensing elements are positioned to provide misalignment information regarding the light sensed by the group of DM sensing elements.

A group of DM sensing elements may include one or more sets of DM sensing elements. A group of feedback sensing elements may include one or more sets of feedback sensing elements. For example—a group of DM sensing elements may include some or all of sets of sensing elements 810, 820, 830, 840, 850, 860, 870 and 880.

According to one or more embodiments the DM optical sensor includes one or more processing circuits that are configured to process the feedback output signals to determine a spatial relationship between an actual location of light sensed by at least some of the sensing elements and an expected location of the light.

According to one or more embodiments the one or more processing circuits do not belong to the DM optical sensor but are in communication with the DM optical sensor.

According to one or more embodiments, the DM optical sensor includes a controller that is configured to trigger (i) a generation of the DM output signals, (ii) a generation of the feedback output signals, (iii) an outputting of the DM output signals, and (iv) an outputting of the feedback signals.

According to one or more embodiments the controller does not belong to the DM optical sensor but is in communication with the DM optical sensor.

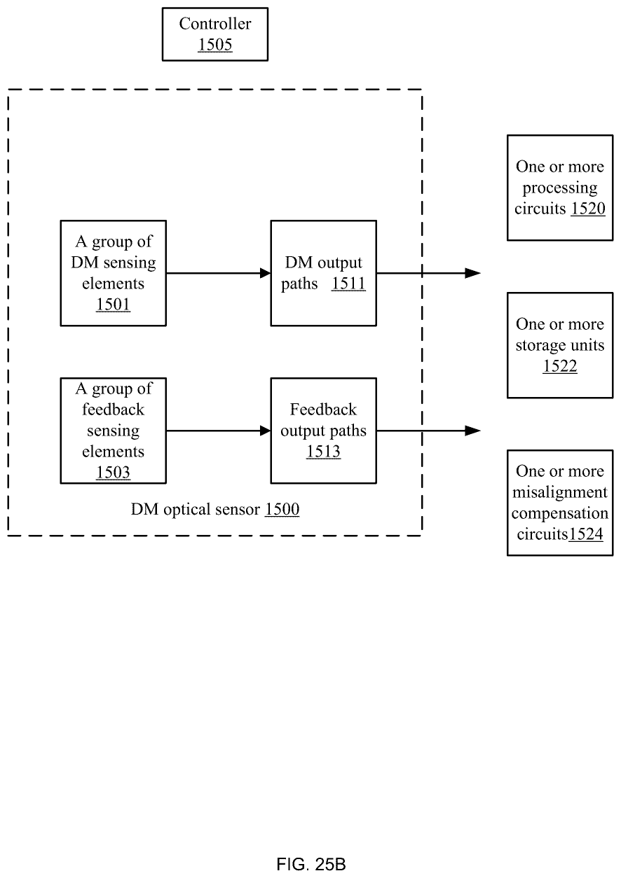

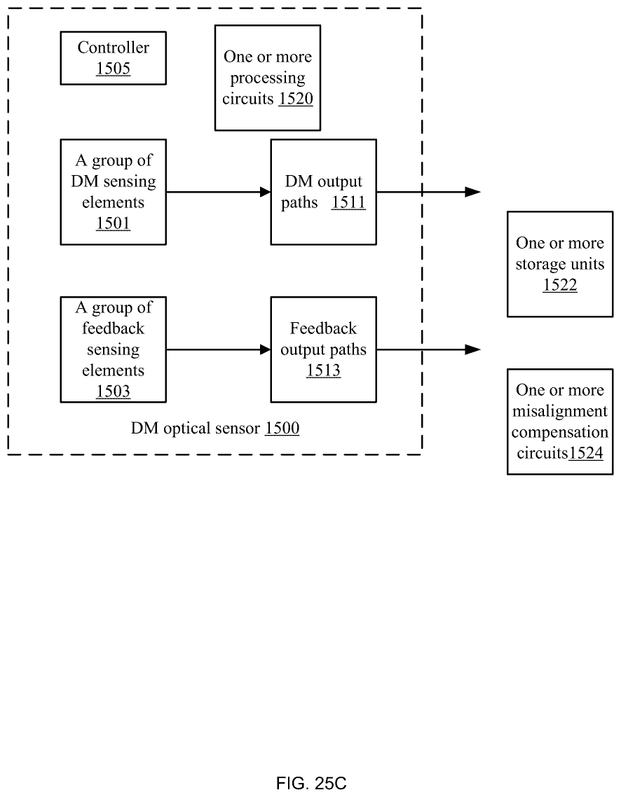

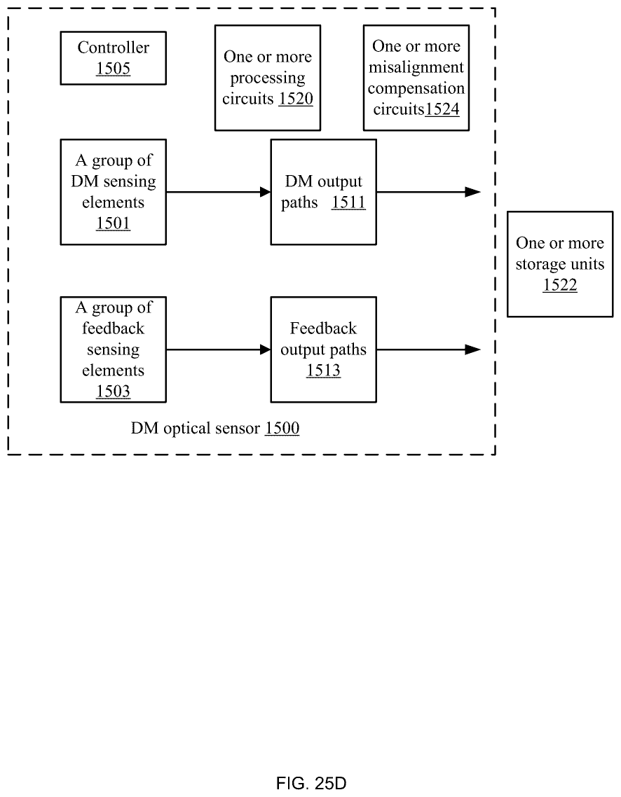

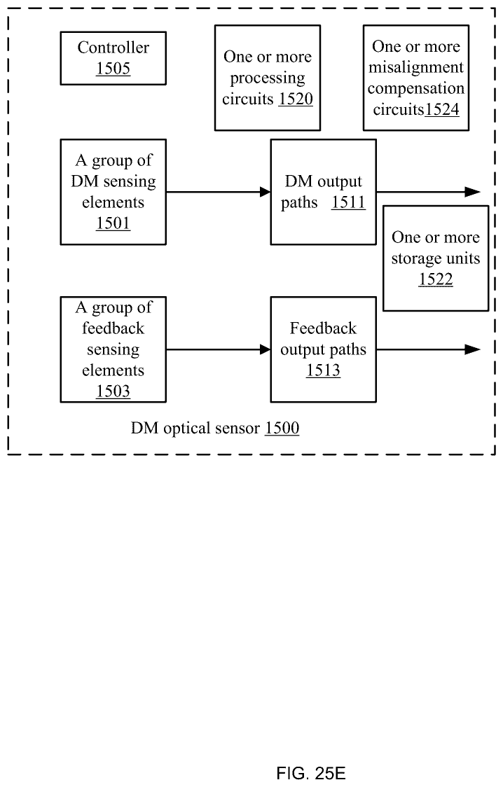

FIGS. 25A, 25B, 25C, 25D, and 25E illustrate examples of a DM optical sensor 1500 that includes a group of DM sensing elements 1501, DM output paths 1511, a group of feedback sensing elements 1503 and feedback output paths 1513.

The DM output paths 1511 may include one or more DM readout circuits 1511-1 and/or one or more DM switching circuits 1511-2. The DM output paths may include or may be limited to buses and/or wires, and the like.

The feedback output paths 1513 may include one or more feedback readout circuits 1513-1 and/or one or more feedback switching circuits 1513-2. The feedback output paths may include or may be limited to buses and/or wires, and the like.

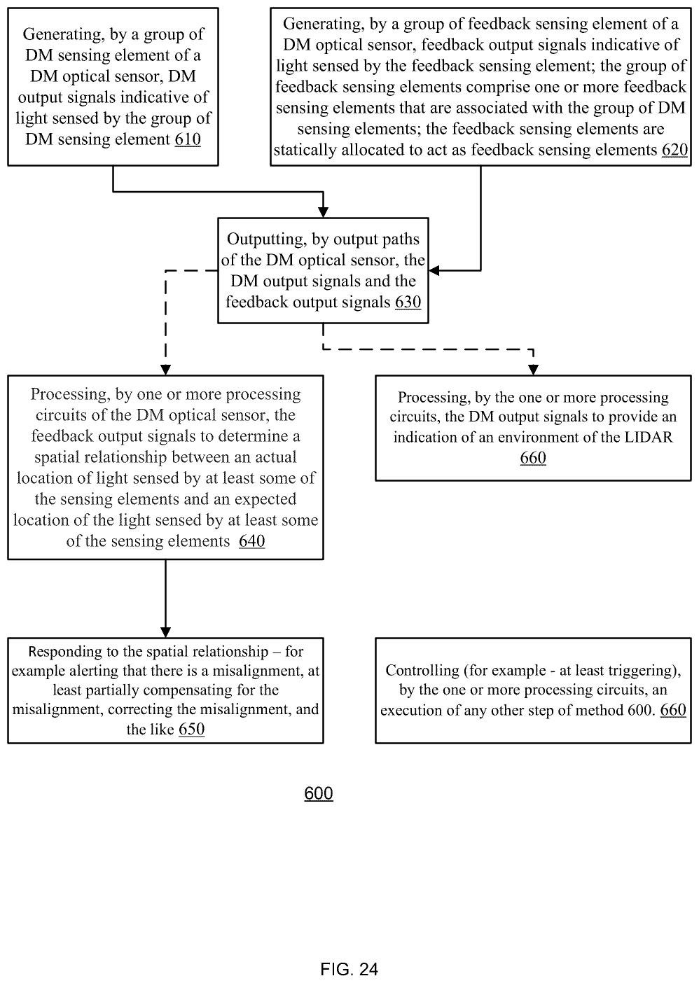

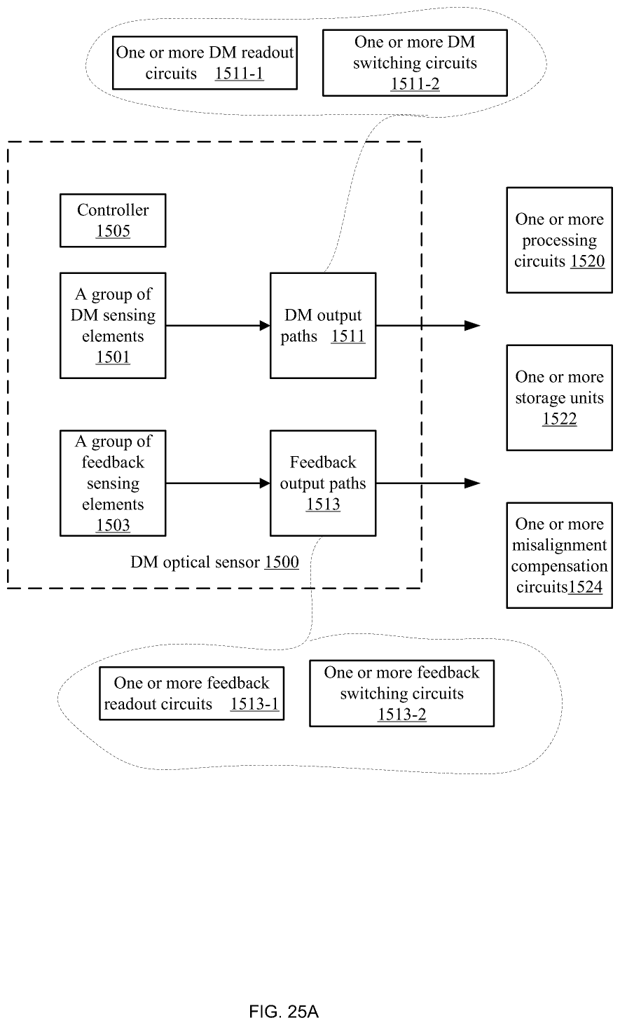

FIGS. 25A, 25B, 25C, 25D, and 25E also illustrate additional elements such as a controller 1501, one or more processing circuits 1520, one or more storage units 1522, and one or more misalignment compensation circuits 1524. Any one of the additional elements may belong to the DM optical sensor 1500 or may be in communication with the DM optical sensor 1500. FIGS. 24A, 25B, 25C, 25D, and 25E illustrates different allocations of additional elements to the DM optical sensor or outside the DM optical sensor.

The DM optical sensor 1500 may belong to LIDAR such as any LIDAR illustrated in the specification and/or drawings. For example—LIDAR 100 of FIG. 1. The one or more processing circuits 1520 may belong to processing unit 102 of FIG. 1.

The group of DM sensing elements 1501 and/or the group of feedback sensing elements 1503 may belong to any sensing unit illustrated in the specification and/or drawings such as to sensing unit 106 of FIG. 1.

According to one or more embodiments, the controller is configured to trigger, multiple times, (i) a generation of the DM output signals, (ii) a generation of the feedback output signals, (iii) an outputting of the DM output signals, and (iv) an outputting of the feedback signals.

One or more times of the multiple times may occur at the same pulse related transmission and reception windows—thereby receiving reflected pulses from objects located at different distances. A pulse related transmission and reception window is a time window allocated to a transmission of a pulse by a LIDAR and for reception of one or more reflected pulses resulting from the transmission of the pulse. A reflected pulse that is received as a certain delay from a start of a pulse related transmission and reception window reflects a distance between the LIDAR and an object from which the light was reflected. Reflected pulses from objects that are closer to the LIDAR are received as shorter delays.

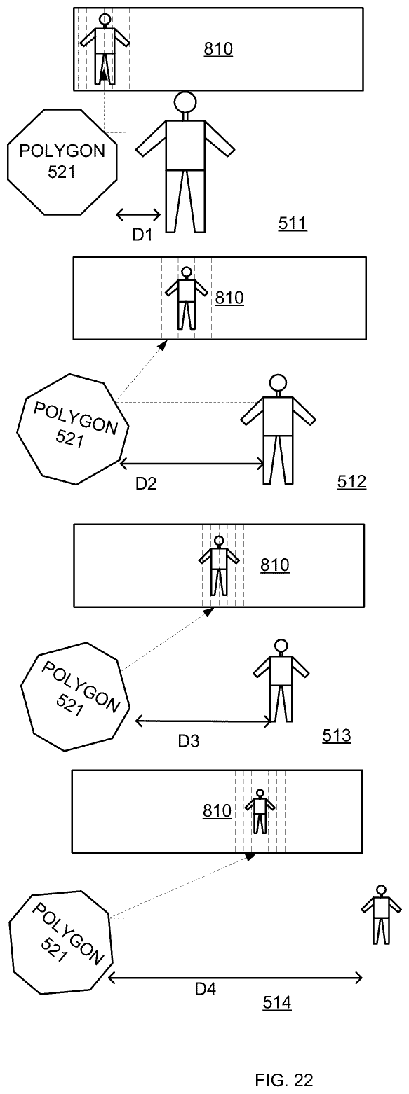

FIG. 22 illustrates an example of reflected pulses from persons that are located at four different distances (D1, D2, D3 and D4) and appear at different locations on a set of DM sensing elements, during a pulse related transmission and reception window. Images 511, 512, 513 and 514 illustrate the detection at four different points in time during the pulse related transmission and reception window. In FIG. 22 a rotating polygon rotates during the pulse related transmission and reception window. For simplicity of explanation any feedback sensing element was not shown.

Different times of the multiple times may occur during different pulse related transmission and reception windows.

The reflected pulses that are sensed at each of the different times are received at a delay from a start of a corresponding pulse related transmission and reception windows, the delay is selected to fall within a predefined delay range.

The predefined delay range may be determined to select reflections from objects located within a desired distance range from the LIDAR.

The desired distance range may be selected based on at least one of:
a. One or more optical properties of the LIDAR.
b. Expected distances between objects and the LIDAR.
c. One or more reflected pulses properties (for example signal to noise ratio).
d. Selecting the desired distance range to receive reflections from targets located within the far field of the LIDAR.
e. Selecting the desired distance range to ignore reflected pulses received from too far objects (for example above a distance of 180 meters).
f. Selecting the desired distance range to receive reflections from objects located within a distance range of 60-120 meters.
g. Selecting the desired distance range based on visibility conditions—for example narrowing the range when the visual conditions deteriorate.

Different times of the multiple times may exhibit a same delay from the start of the corresponding pulse related transmission and reception windows. This enables a reception of reflected pulses from objects located at the same distance from the LIDAR.

The group of feedback sensing elements may include vertical alignment indicative feedback sensing elements and/or horizontal alignment indicative feedback sensing elements.

At least one feedback sensing element may have a lower spatial resolution from at least one DM sensing element. For example—a DM sensing element may have more detecting elements than a feedback sensing element—for example—by more than 5, 10, 15, 20, 25, 30, 35, 40, 45, 50, 55, 60, 65, 70, 75, 100, 150, 200 and more percent.

The DM sensing elements may be arranged in sets of DM sensing elements, wherein at least some of the sets of DM sensing elements are associated with one or more feedback sensing elements. A set of feedback sensing elements are associated with a set of DM sensing elements in the sense that the set of feedback sensing elements are positioned to provide misalignment information regarding the light sensed by the set of DM sensing elements. For example—the set of DM sensing elements are allocated to sense reflected pulses originated from a transmitted pulse of a certain light beam then the associated set of feedback sensing elements should provide alignment information regarding the reflected pulses originated from the transmitted pulse of the certain light beam.

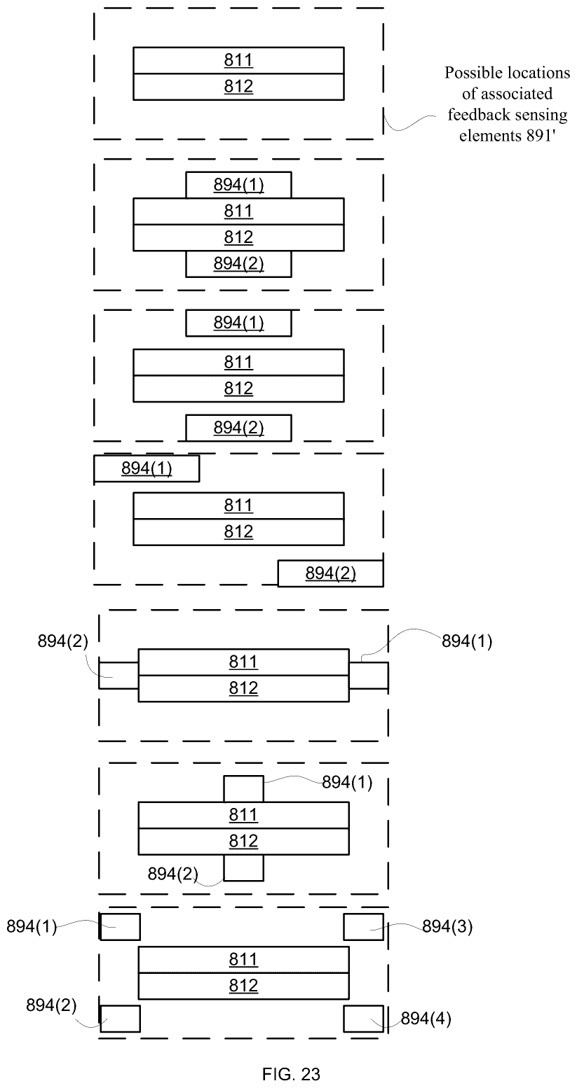

FIG. 23 illustrates a set of DM sensing elements that includes sensing elements 811 and 812. This set is surrounded by a region 891′ that defines the possible locations of associated feedback sensing elements. FIG. 23 illustrates different examples of feedback sensing elements (such as 894(1), 294(2), 294(3) and 294(4) located within the region. There may be any number of feedback sensing elements with the region.

The one or more processing circuits are configured to trigger the outputting of the feedback output signals multiple times and are configured to trigger the outputting of the DM output signals multiple times.

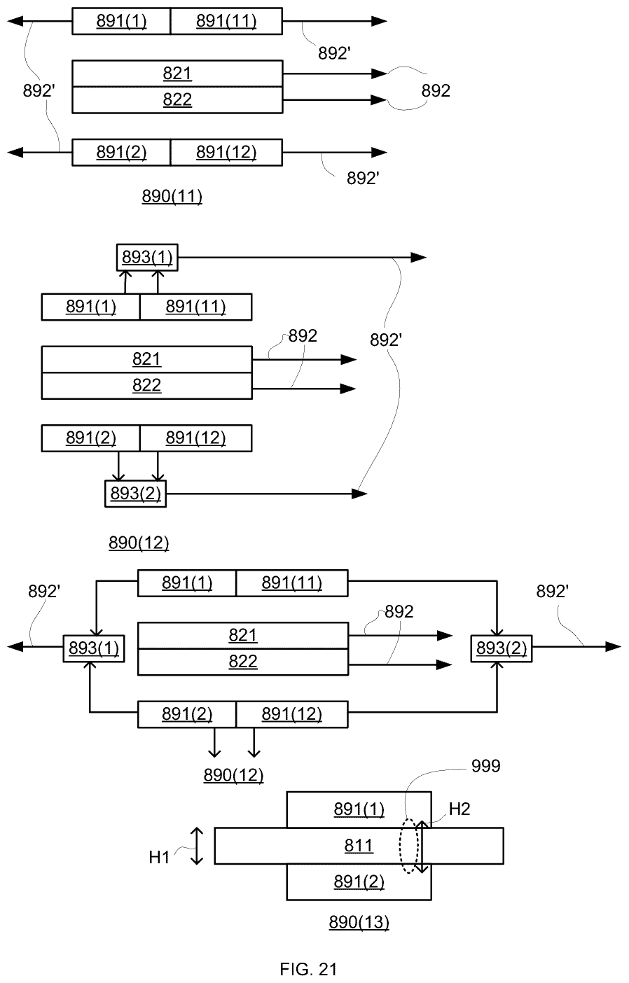

The reflected pulses may form light spots on the set of DM sensing elements and their height may exceed the height of the set of DM sensing elements. The set of feedback sensing elements associated with the set of DM sensing elements are also shaped and positioned to receive at least a portion of the light spots (see, for example, FIG. 21—fourth example 890(12)). In order to measure vertical alignment—the height of the light spots should be large enough to allow the light spots to fall on both the set of DM sensing elements and the set of feedback sensing elements.

The height of light spot may exceed the height of the set of DM sensing elements by any amount (for example between 2-80 percent, by 2-10 percent, by 8-12 percent, and the like). Smaller differences between the height of light spot and the height of the set of DM sensing elements allow more light to be detected by the DM sensing elements—and may increase the signal to noise ratio of the light sensed by the DM sensing elements.

A DM sensing element may include a 2D array of DM detection elements and a feedback sensing element may include a 2D array of feedback sensing elements. This is applicable to one, some or all of the DM sensing elements of the group of DM sensing elements and/or to one, some or all of the feedback sensing elements of the group of feedback sensing elements.

A number of DM detection elements per row of the 2D array of DM detection elements may be smaller than or may be equal to or may exceed a number of feedback sensing elements per row of the 2D array of feedback detection elements.

A number of DM detection elements per column of the 2D array of DM detection elements may be smaller than or may be equal to or may exceed a number of feedback sensing elements per column of the 2D array of feedback detection elements.

At least one of the feedback output paths may include a subtraction circuit for calculating a difference between light sensed by different feedback detection elements. See, for example, FIG. 21.

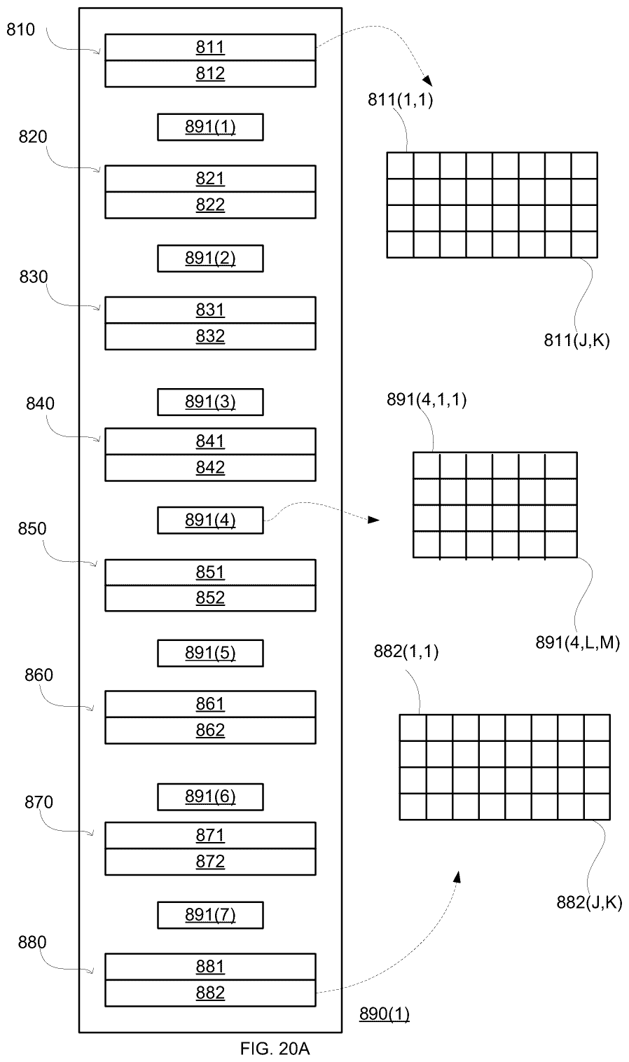

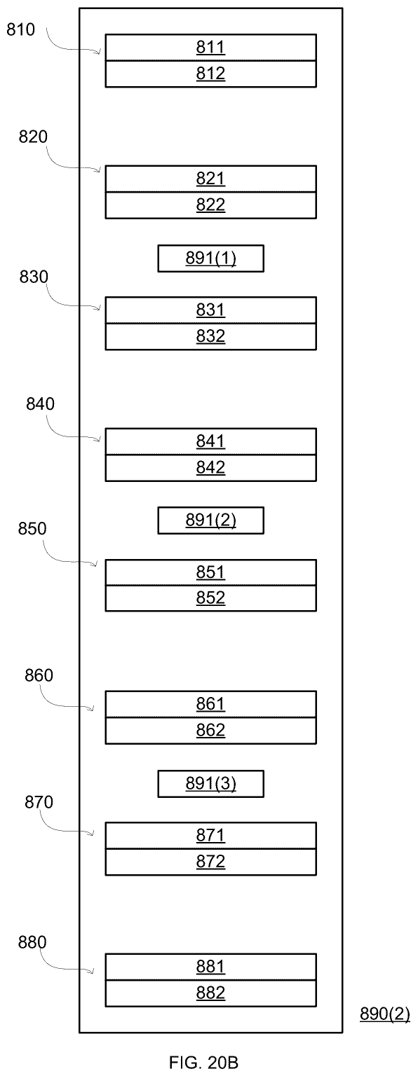

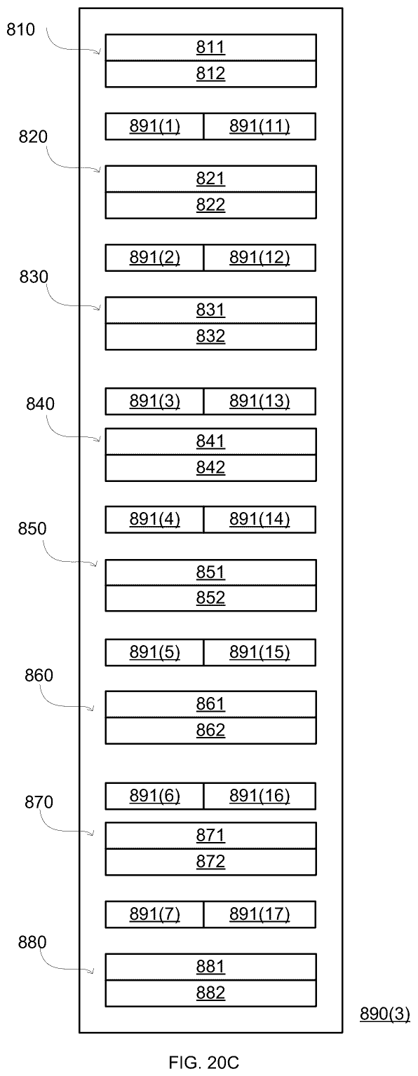

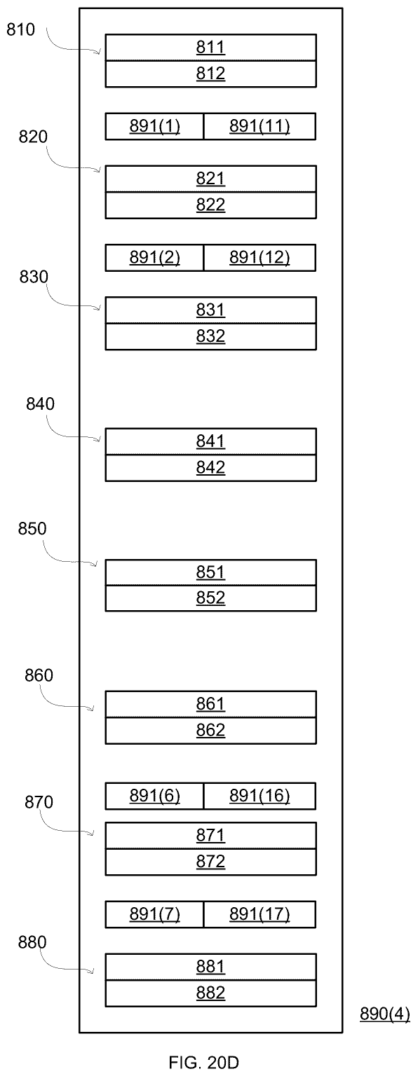

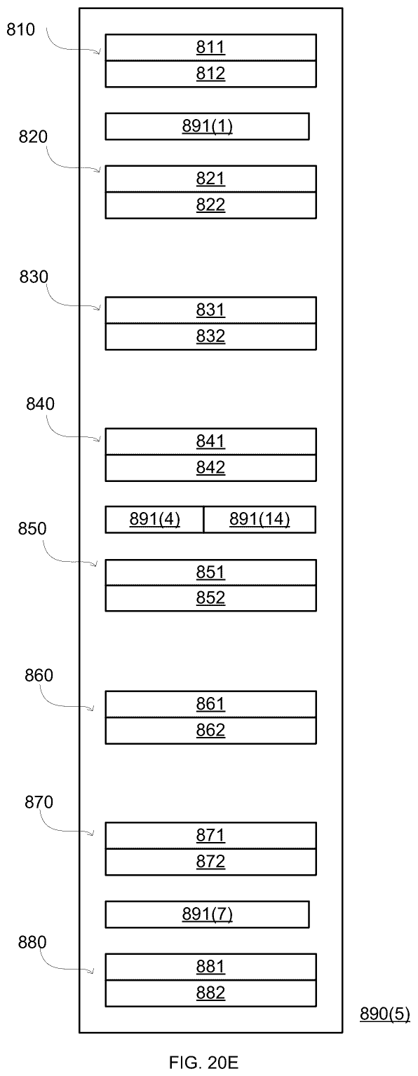

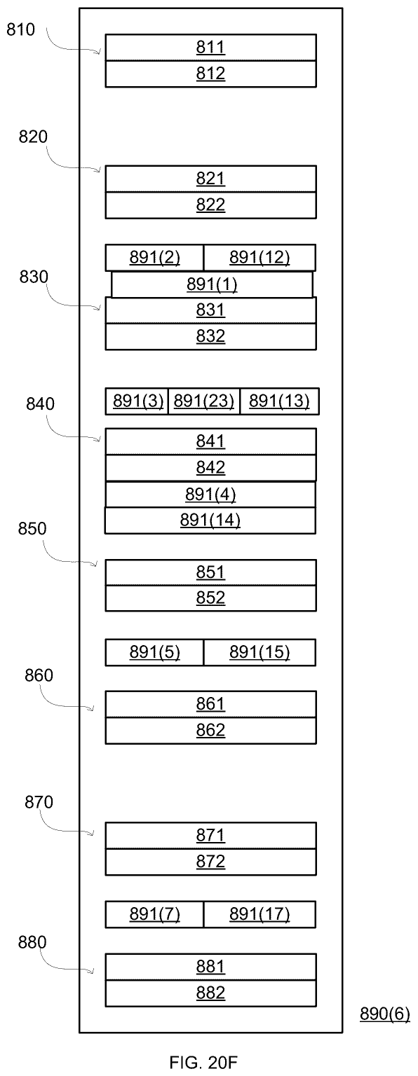

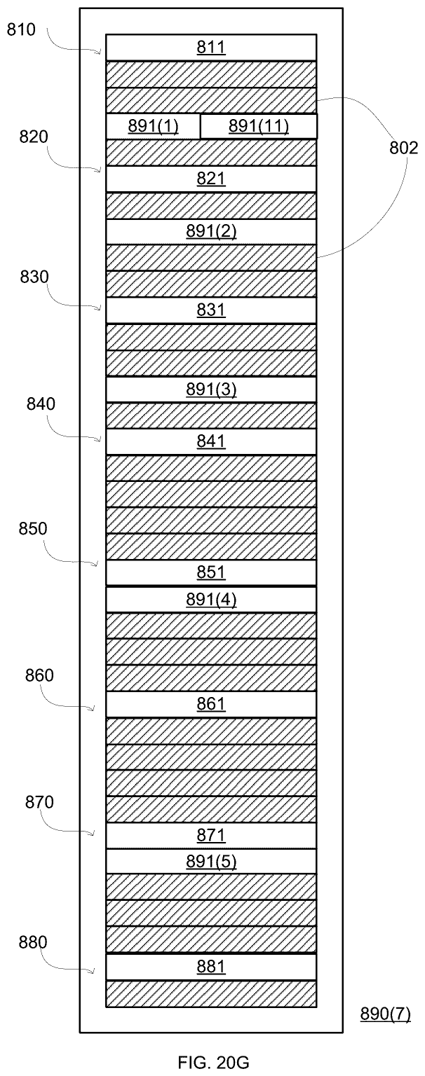

DM sensing elements may be spaced apart, by inactive sensing elements of the two-dimensional sensing array, from the feedback sensing elements. See, for example, FIG. 20G.

A number of feedback output paths may be configured to perform time division multiplexing between feedback output signals of a number of feedback sensing elements, the number of the feedback sensing element exceeds a number of the output paths.

One feedback sensing element of the group of feedback sensing elements may have a different size than another feedback sensing element of the group of feedback sensing elements. See, for example the size of feedback sensing element 891(1) of FIG. 20F in comparison to the size of each one of feedback sensing elements 891(2) and 891(12) of FIG. 20F.

The DM optical sensor according to claim 1, wherein, one feedback sensing element of the group of feedback sensing elements has a different shape than another feedback sensing element of the group of feedback sensing elements.

It should be noted that the one or more processing circuits may be configured to determine the spatial relationship based also on at least some of the DM output signals. For example—assuming that a set of DM sensing elements include a pair of sensing elements (for example—see first set 810 that include sensing elements 811 and 812) that are expected to sense different parts of the same light spots. In this case the difference between the sensing signals of the different sensing elements may provide vertical misalignment information.

The DM optical sensor may include one or more misalignment compensation circuits for compensating for a misalignment between the actual location of light sensed by at least some of the sensing elements and the expected location of the light. The misalignment compensation circuits may be one of the one or more processing circuits (for example may correct misalignment by timing the transmission of pulses and/or by controlling the reception—for example selecting the timing of reading of detection elements of the sensing elements), and/or may be mechanical or temperature changing units, and the like. A misalignment compensation circuit can be a dedicated circuit, a multi-role circuit, an adjustable mirror, a scanner, a laser workplan, a controller for controlling transmission and/or reception of light, a heater, a cooler, and the like.

The number of the output paths may be smaller than a number of the sensing elements. The number of the feedback sensing elements may be smaller than a number of the DM sensing elements.

FIG. 21 illustrates DM sensing elements 821 and 822 and four feedback sensing elements 891(1), 891(11), 891(2) and 891(12).

FIG. 21 illustrates four examples.

In the first example there is provided an feedback output path 892′ per each one of feedback sensing element out of 891(1), 891(11), 891(2) and 891(12). In the first example there is provided a DN output path 892 per each one of DM sensing element out of 821 and 822.

In the second example a first subtraction unit 893(1) calculates a first horizontal difference signal between the outputs of feedback sensing elements 891(1) and 891(11), a second subtraction unit 893(2) calculates a second horizontal difference signal between the outputs of feedback sensing elements 891(2) and 891(12), and there is provided a feedback output path 892′ per each one of the first and second horizontal difference signals. There is also provided a DN output path 892 per each one of DM sensing element out of 821 and 822.

In the third example the first subtraction unit 893(1) calculates a first vertical difference signal between the outputs of feedback sensing elements 891(1) and 891(2), the second subtraction unit 893(2) calculates a second vertical difference signal between the outputs of feedback sensing elements 891(11) and 891(12), and there is provided a feedback output path 892′ per each one of the first and second vertical difference signals. There is also provided a DN output path 892 per each one of DM sensing element out of 821 and 822.

The fourth example illustrates a spot 999 having a height (H2) that exceeds a height (H1) of a set 811 of DN sensing elements 811. Feedback sensing elements 891(1) and 891(2) are adjacent to the DN sensing elements and may detect a part of the spot.

FIGS. 20A-20G illustrates various examples of arrays of sensing elements. The number and/or arrangement and/or shape and/or size of sensing elements and/or DM sensing elements and/or feedback sensing elements may differ from those illustrated in any one of FIGS. 20A-20G. Each sensing element may include one or more detection elements. A detection element may be a diode such as a SPAD or any other sensing elementary unit. FIG. 20A illustrates that each sensing element may include a 2D array of detection elements. FIG. 20A illustrates DM sensing element 811 as including J rows and K columns of DM detection elements 811(1,1)-811(J,K), illustrates DM sensing element 882 as including J rows and K columns of DM detection elements 882(1,1)-882(J,K), and illustrates feedback sensing element 891(4) as including L rows and M columns of feedback detection elements 891(4,1,1)-891(4,J,K). J, K, L and M are positive integers. There may be any relationship between the values of J, K, L and M. In FIG. 20A K exceeds M and L equals J.

Light spots of different reflected pulses may scan the detection elements during a pulse related transmission and reception window—so that reflected pulses from objects located at different distances that are distance enough from each other may impinge on different detection elements.

In FIGS. 20A-20F the array includes eight sets of DM sensing elements 810, 820, 830, 840, 850, 860, 870 and 880. Each set includes two DM sensing elements (811, 812) of set 810, (821, 822) of set 820, (831, 832) of set 830, (841, 842) of set 840, (851, 852) of set 850, (861, 862) of set 860, (871, 872) of set 870, and (881, 882) of set 880. The DM sensing elements may be a part of a monolithic sensing array.

The number of sets may be smaller than eight, or may exceed eight. For example—the number of sets may be 16, 32, or 36. The number of sensing elements per set may be one (see for example— FIG. 20G), may be two or may exceed two. The number of DM sensing element in one or more sets may differ from the number of sensing elements in one more other sets. The DM sensing elements may be arranged in a 2D array, a 3D array, in an unordered manner, and the like.

In FIGS. 20A-20F differ from each other by the feedback sensing elements.

Array 890(1) of FIG. 20A includes seven feedback sensing elements 891(1)-891(7)—each feedback sensing element is positioned between two sets of DM sensing elements.

Array 890(2) of FIG. 20B also include three feedback sensing elements 891(1)-891(3)— each feedback sensing element is positioned between two sets of DM sensing elements.

Array 890(3) of FIG. 20C includes fourteen feedback sensing elements 891(1)-891(7) and 891(11)-891(17) that are arranged in pairs—each pair may provide horizontal difference information and is positioned between two sets of DM sensing elements.

Array 890(3) of FIG. 20C includes fourteen feedback sensing elements 891(1)-891(7) and 891(11)-891(17) that are arranged in pairs—each pair may provide horizontal difference information and is positioned between two sets of DM sensing elements.

Array 890(4) of FIG. 20D includes eight feedback sensing elements 891(1), 891(11), 891(2), 891(12), 891(6), 891(16), 891(7) and 891(17) that are arranged in pairs—each pair may provide horizontal difference information and is positioned between two sets of DM sensing elements.

Array 890(5) of FIG. 20E includes four feedback sensing elements 891(1), 891(4), 891(14), and 891(7)— wherein feedback sensing elements form a pair and feedback sensing elements are single sensing elements—whereas the pair may provide horizontal difference information and is positioned between two sets of DM sensing elements.

Array 890(6) of FIG. 20F includes twelve feedback sensing elements—a pair of feedback sensing elements 891(2) and 891(12), a single feedback sensing elements 891(1), a triplet of feedback sensing elements 891(3), 891(13) and 891(13), two single feedback sensing elements 891(4) and 891(14), another pair of feedback sensing elements 891(5) and 891(15), and a further pair of feedback sensing elements 891(7) and 891(17).

Array 890(7) of FIG. 20G illustrates light inactive regions 802 between feedback sensing elements and/or DM sensing elements. In FIG. 20G there are eight sets of DM sensing elements—each set includes a single DM sensing element 811, 821, 831, 841, 851, 861, 871 and 881.

Array 890(7) also includes six feedback sensing elements—a pair of feedback sensing elements 891(1) and 891(11), and four single feedback sensing elements 891(2), 891(3), 891(4) and 891(5).

FIG. 24 illustrates an example of method 600.

Method 600 may include steps 610 and 620.

Step 610 may include generating, by a group of DM sensing elements of a DM optical sensor, DM output signals indicative of light sensed by the group of DM sensing element.

Step 620 may include generating, by a group of feedback sensing element of a DM optical sensor, feedback output signals indicative of light sensed by the feedback sensing element; the group of feedback sensing elements comprise one or more feedback sensing elements that are associated with the group of DM sensing elements; the feedback sensing elements are statically allocated to act as feedback sensing elements.

Step 610 and/or step 620 may be executed once or at least two times during at least one pulse related transmission and reception window.

Steps 610 and 620 may be followed by step 630 of outputting, by output paths of the DM optical sensor, the DM output signals and the feedback output signals.

There may be any timing relationship between an outputting of one output signal (DM and/or feedback) to an outputting of another output signal.

According to one or more embodiments—method 600 also includes step 640 and/or step 650 and/or step 660 and/or step 670.

Step 640 includes processing, by one or more processing circuits of the DM optical sensor, the feedback output signals to determine a spatial relationship between an actual location of light sensed by at least some of the sensing elements and an expected location of the light sensed by at least some of the sensing elements.

Step 640 may include processing based on signals generated by one or more iterations of steps 610, 620 and 630.

Step 650 includes responding to the spatial relationship—for example alerting that there is a misalignment, at least partially compensating for the misalignment, correcting the misalignment, and the like.

Step 660 includes processing, by the one or more processing circuits, the DM output signals to provide an indication of an environment of the LIDAR.

Step 670 includes controlling (for example—at least triggering), by a controller, an execution of any other step of method 600. The triggering may include sending control signals and/or sensing commands and/or supplying power, and the like.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

We claim:

1. A distance measurement (DM) optical sensor, comprising:
a two-dimensional (2D) sensing array comprising sensing elements; wherein the sensing elements comprise DM sensing elements and feedback sensing elements;
wherein the feedback sensing elements are statically allocated to act as feedback sensing elements; and
output paths that comprise DM output paths and feedback output paths;
wherein a group of DM sensing elements of the DM sensing elements are configured to generate DM output signals that are indicative of light sensed by the group of DM sensing elements;
wherein the DM output paths are configured to output the DM output signals;
wherein a group of feedback sensing elements of the feedback sensing elements are configured to generate feedback output signals that are indicative of light sensed by the group of feedback sensing elements; and
wherein the feedback output paths are configured to output the feedback output signals.

2. (canceled)

3. The DM optical sensor according to claim 1, comprising a controller that is configured to trigger (i) a generation of the DM output signals, (ii) a generation of the feedback output signals, (iii) an outputting of the DM output signals, and (iv) an outputting of the feedback signals.

4. The DM optical sensor according to claim 1, comprising a controller that is configured to trigger, multiple times, (i) a generation of the DM output signals, (ii) a generation of the feedback output signals, (iii) an outputting of the DM output signals, and (iv) an outputting of the feedback signals.

5. The DM optical sensor according to claim 4, wherein different times of the multiple times occur during different pulse related transmission and reception windows.

6. (canceled)

7. (canceled)

8. (canceled)

9. (canceled)

10. The DM optical sensor according to claim 5, wherein at least some of the different times have different delays from starts of at least some of the corresponding pulse related transmission and reception windows.

11. The DM optical sensor according to claim 4, wherein there are two or more times of the multiple times per each pulse related transmission and reception windows.

12. The DM optical sensor according to claim 4, wherein the DM sensing elements are arranged in sets of DM sensing elements, each set of DM sensing elements is allocated to receive, during a time of the multiple times, a spot of light; wherein a height of the spot of light exceeds a height of the set of DM sensing elements.

13. The DM optical sensor according to claim 12, wherein the height of the spot of light exceeds by three till fifteen percent the height of the set of DM sensing elements.

14. The DM optical sensor according to claim 1, wherein a DM sensing element comprises a 2D array of DM detection elements and a feedback sensing element comprises a 2D array of feedback sensing elements.

15. (canceled)

16. (canceled)

17. The DM optical sensor according to claim 1, wherein at least one of the feedback output paths comprises a subtraction circuit for calculating a difference between light sensed by different feedback detection elements.

18. (canceled)

19. (canceled)

20. (canceled)

21. The DM optical sensor according to claim 1, wherein a number of feedback output paths that are configured to perform time division multiplexing between feedback output signals of a number of feedback sensing elements, the number of the feedback sensing element exceeds a number of the output paths.

22. The DM optical sensor according to claim 1, wherein, one feedback sensing element of the group of feedback sensing elements has a different size than another feedback sensing element of the group of feedback sensing elements.

23. The DM optical sensor according to claim 1, wherein, one feedback sensing element of the group of feedback sensing elements has a different shape than another feedback sensing element of the group of feedback sensing elements.

24. (canceled)

25. The DM optical sensor according to claim 1, comprising one or more misalignment compensation circuits for compensating for a misalignment between the actual location of light sensed by at least some of the sensing elements and the expected location of the light.

26. The DM optical sensor according to claim 1, wherein a number of the output paths is smaller than a number of the sensing elements, and wherein a number of the feedback sensing elements are smaller than a number of the DM sensing elements.

27. The DM optical sensor according to claim 1, wherein the group of feedback sensing elements comprises vertical alignment indicative feedback sensing elements.

28. The DM optical sensor according to claim 1, wherein the group of feedback sensing elements comprises horizontal alignment indicative feedback sensing elements.

29. The DM optical sensor according to claim 1, wherein at least one feedback sensing element has a lower spatial resolution from at least one DM sensing element.

30. (canceled)

31. A method for distance measurement (DM), the method comprising:
(a) generating, by a group of DM sensing element of a DM optical sensor, DM output signals indicative of light sensed by the group of DM sensing element;
(b) generating, by a group of feedback sensing element of a DM optical sensor, feedback output signals indicative of light sensed by the feedback sensing element; the group of feedback sensing elements comprise one or more feedback sensing elements that are associated with the group of DM sensing elements; the feedback sensing elements are statically allocated to act as feedback sensing elements; and
(c) outputting, by output paths of the DM optical sensor, the DM output signals and the feedback output signals.

32. (canceled)

33. (canceled)

34. A non-transitory computer readable medium that stores instructions that once executed by a controller, causes the controller to:
(a) trigger a generating, by a group of DM sensing element of a DM optical sensor, DM output signals indicative of light sensed by the group of DM sensing element;
(b) trigger a generating, by a group of feedback sensing element of a DM optical sensor, feedback output signals indicative of light sensed by the feedback sensing element; the group of feedback sensing elements comprise one or more feedback sensing elements that are associated with the group of DM sensing elements; the feedback sensing elements are statically allocated to act as feedback sensing elements; and
(c) trigger an outputting, by output paths of the DM optical sensor, the DM output signals and the feedback output signals.
